(19) United States
(12) Patent Application Publication
(10) Pub. No.: US 2013/0226639 A1
(43) Pub. Date: Aug. 29, 2013

(54) TASK MANAGEMENT METHOD AND TASK MANAGEMENT APPARATUS

(71) Applicants: Shoichi Yokoyama, Yokohama (JP); Takeshi Anzai, Yokohama (JP); Takeshi Arisaka, Yokohama (JP)

(72) Inventors: Shoichi Yokoyama, Yokohama (JP); Takeshi Anzai, Yokohama (JP); Takeshi Arisaka, Yokohama (JP)

(73) Assignee: Hitachi, Ltd., Tokyo (JP)

(21) Appl. No.: 13/581,985

(22) PCT Filed: Feb. 27, 2012
(86) PCT No.: PCT/JP2012/054834

§ 371 Date: Aug. 30, 2012

(51) Int. Cl. G06Q 10/06

(52) U.S. Cl. 705/7.14

(57) ABSTRACT

A task management apparatus configured to assign tasks to a plurality of operators is constructed. The task management apparatus stores task information including, for each generated task, operation target information for which a value is determined according to a state at the time of task occurrence and which is related to a task target. The task management apparatus calculates, based on the task information, the task similarity between a newly generated first task and a second task that is already assigned to an operator, for each of the operators, and determines an operator to whom the first task is assigned according to assignment priority based on the task similarity calculated for each of the operators.

### TECHNICAL FIELD

The present invention relates a technique for managing tasks in a task management apparatus configured to assign a task to a plurality of operators.

### BACKGROUND ART

A known technique for assigning a task to a plurality of operators is to determine a task assignee based on task similarity and operator's skill (e.g. see Patent Literature 1).

Patent Literature 1 discloses a workflow management system configured to dynamically construct a workflow model during workflow execution. This workflow management system includes: a task information acquisition unit configured to acquire a task name and specific information from an operating task when a search request is issued for a human resource or task; a skill profile information input unit configured to input skill profile information including the skill name upon the search request; a similar task search unit configured to search a similar existing task based on task information; a relevant party finding unit configured to find a relevant party of the searched task; a check unit configured to check the consistency with the skill profile information based on the relevant party searched in the relevant party finding unit; a skill search unit configured to search a human resource having a common skill, based on the skill profile information; and an integration unit configured to calculate ranking points of human resources or tasks and present them in order from the highest point.

### CITATION LIST

### Patent Literature

### [Patent Literature 1]

Japanese Patent Laid-Open No. 2009-223832

### SUMMARY OF INVENTION

### Technical Problem

According to the technique disclosed in Patent Literature 1, an operator to whom a task is assigned is determined based on task similarity and operator's skill. To be more specific, a task assignee is determined based on the fact that: the operator to whom a task is assigned has a skill to accomplish a task of the assignment target; and the similarity is high between a task assigned in advance to the operator to whom a task is assigned (i.e. a task held by the operator to whom a task is assigned) and the assignment target task. In the technique disclosed in Patent Literature 1, the similarity between the assignment target task and the existing task is calculated based on static information defined in advance before the assignment target task is generated.

In an attempt to improve the task performance efficiency by asking the same operator to process similar tasks, it is important to determine a task similarity as to how similar the tasks are, and therefore there is a need for improving the accuracy of the task similarity determination.

Also, when a task is assigned to a plurality of operators, the task performance efficiency is influenced by not only assigned-task similarity but also various situations.

### Solution to Problem

A task management apparatus to perform task assignment for a plurality of operators is constructed. The task management apparatus stores task information including operation target information, which has a value determined based on the situation at the time of task generation and which is related to the task target, for each of generated tasks. Based on the task information, for each operator, the task management apparatus calculates task similarity between a newly-generated first task and a second task assigned to the operator, and, according to assignment priority based on the task similarity calculated for each operator, determines an operator to whom the first task is assigned.

### BRIEF DESCRIPTION OF DRAWINGS

FIG. 1 is a configuration diagram of a client management system according to Embodiment 1.

FIG. 2 is a diagram illustrating one example of operator information according to Embodiment 1.

FIG. 3 is a diagram illustrating one example of task information according to Embodiment 1.

FIG. 4 is a diagram illustrating one example of elapsed-time limit information according to Embodiment 1.

FIG. 5 is a diagram illustrating one example of caution task information according to Embodiment 1.

FIG. 6 is a diagram illustrating one example of recommendation task information according to Embodiment 1.

FIG. 7 is a diagram illustrating one example of task history information according to Embodiment 1.

FIG. 8 is a flowchart of task assignment and recommendation processing according to Embodiment 1.

FIG. 9 is a flowchart of new task assignment processing according to Embodiment 1.

FIG. 10 is a flowchart of maximum similarity calculation processing according to Embodiment 1.

FIG. 11 is a flowchart of similarity calculation processing according to Embodiment 1.

FIG. 12 is a flowchart of calculation processing of a task holding ratio according to Embodiment 1.

FIG. 13 is a flowchart of calculation processing of dynamic weighting similarity according to Embodiment 1.

FIG. 14 is a diagram which specifically illustrates calculation processing of dynamic weighting similarity according to Embodiment 1.

FIG. 15 is a flowchart of caution task extraction processing according to Embodiment 1.

FIG. 16 is a flowchart of caution task recommendation processing according to Embodiment 1.

FIG. 17 is a flowchart of processing at the time of task launch according to Embodiment 1.

FIG. 18 is a flowchart of processing at the time of task completion according to Embodiment 1.

FIG. 19 is a flowchart of display processing of a task management state according to Embodiment 1.

FIG. 20 is a diagram illustrating one example of a task management state display screen according to Embodiment 1.

FIG. 21 is a diagram illustrating one example of a parameter configuration screen according to Embodiment 1.

FIG. 22 is a configuration diagram of a workflow management system according to Embodiment 2.

FIG. 23 is a diagram illustrating one example of operator information according to Embodiment 2.

FIG. 24 is a diagram illustrating one example of template task information according to Embodiment 2.

FIG. 25 is a diagram illustrating one example of workflow information according to Embodiment 2.

FIG. 26 is a diagram illustrating one example of task instance information according to Embodiment 2.

FIG. 27 is a diagram illustrating one example of task history information according to Embodiment 2.

FIG. 28 is a flowchart of task assignment and recommendation processing according to Embodiment 2.

FIG. 29 is a flowchart of manual task assignment processing according to Embodiment 2.

FIG. 30 is a flowchart of maximum similarity calculation processing according to Embodiment 2.

### DESCRIPTION OF EMBODIMENTS

Several embodiments will be explained with reference to the drawings. It should be noted that the embodiments described below do not limit the claimed inventions set forth in the scope of claims, and all components and their combinations described in the embodiments are not necessarily essential for solution to problems of the invention. In these drawings, the common reference numerals in the drawings show the same components.

It should be noted that, in the following explanation, although expression “aaa information” is used for explanation, this information may be expressed by a data structure such as a “table,” “DB” and “cue.”

Further, when explain the content of each information, although expression “identification information,” “identifier,” “name,” “appellation” and “ID” are used, these can be replaced with each other.

In the following explanation, although an explanation is given using a “program” as the subject, the program is executed by a processor to perform determined processing using a memory and a communication port (i.e. communication I/F), and therefore the explanation may be given using the processor. Also, disclosed processing using a program as a subject may be processing performed by a computer such as a management server computer. Also, part or all of processing performed by executing a program by a processor may be realized by a hardware circuit. Also, various programs may be installed in each computer by a program distribution server or a computer-readable storage medium.

In the following, main terms used in the explanation of embodiments will be described.

(1) A “task” denotes an operation executed by human in a management operation (specifically, client management or operational management) using a computer system, such as an operation to deal with an event occurred in a management operation. Referring to an example case where a certain client installs unauthorized software in a computer and uses it, the event denotes the action of using the unauthorized software, and the task denotes an operation of dealing with the event, for example, an operation of reporting to the client that a use of the software is not authorized and causing the software to be uninstalled from the computer. Also, referring to an example case where a certain printer breaks down, the event denotes the printer failure and the task denotes an operation of dealing with the failure, for example, an operation of reporting the failure to the printer's manager or repairing it by itself. An event is automatically detected by a computer, for example.

(2) An “operator” denotes a person who executes a task. In a management operation, for example, the operator denotes a manager or operator.

(3) “Operation target information” denotes information related to a person or object of a task target. For example, in the case of the above example where unauthorized software is used, the task target person or object denotes a client who installed the unauthorized software or a computer in which the unauthorized software was installed, and information related to these is operation target information. In this case, the operation target information includes: the client name who installed the unauthorized software; an organization to which the client belongs; the name of the computer in which the unauthorized software was installed; the OS (Operating System) mounted on the computer; and an operation log of the computer. Also, in the above case of printer failure, the task target object or person denotes the failed printer or the manager of the failed printer and information related to these is the operation target information. This operation target information has a value defined according to a situation at the time of task generation. In the above example of printer failure, the organization to which the printer belongs or the printer manager may be changed, that is, they are not always the same and therefore cannot be set in advance to a specific organization or specific manager. In contrast, at the time a task to deal with the printer failure is generated, an organization to which the printer belongs and the printer manager are specified.

(4) “Task basic information” denotes information of the task generation time and date, a category to which the task belongs, the task importance, task content, task procedure and task itself. The task basic information is distinguished from the operation target information.

(5) “Task information” denotes task-related information including the task basic information and the operation target information.

(6) A “task item” denotes each information item of the task information.

(7) A “new task” denotes a task which is newly generate and is not assigned to an operator yet, that is, for which a charged operator is not determined.

(8) An “assigned task” denotes a task which is already assigned to an operator, that is, for which a charged operator is determined.

(9) A “caution task” denotes a task in a state where it is not launched over a constant time period among assigned tasks.

(10) An “elapsed-time limit” denotes a reference time period for a time period during which a non-launched state continues and which is used to determine an assigned task as a caution task. The elapsed-time limit has a varying value configured according to, for example, the task importance.

(11) A “recommendation task” denotes a task recommended to be executed together with the new task for an operator to whom the new task is assigned, among caution tasks. It should be noted that an operator in charge of the recommendation task is still an operator to whom the recommendation task was assigned when the recommendation task was the new task, and is not changed to a recommended operator.

(12) A “template task” denotes a task in which information that can be defined in advance (such as a category to which a task belongs, a task importance and task content) among task basic information is defined. The template task is a component to define a workflow.

(13) A “workflow” denotes a task sequence defined by a combination of template tasks so as to achieve a certain object. It should be noted that the tasks in the workflow are executed in order of the task sequence.

(14) A “task instance” denotes a generated task in a case where the task corresponding to a template task is actually generated, that is, a task including information defined in the template task (i.e. information that can be defined before the task is generated) and further information specified at the time of task generation.

### Embodiment 1

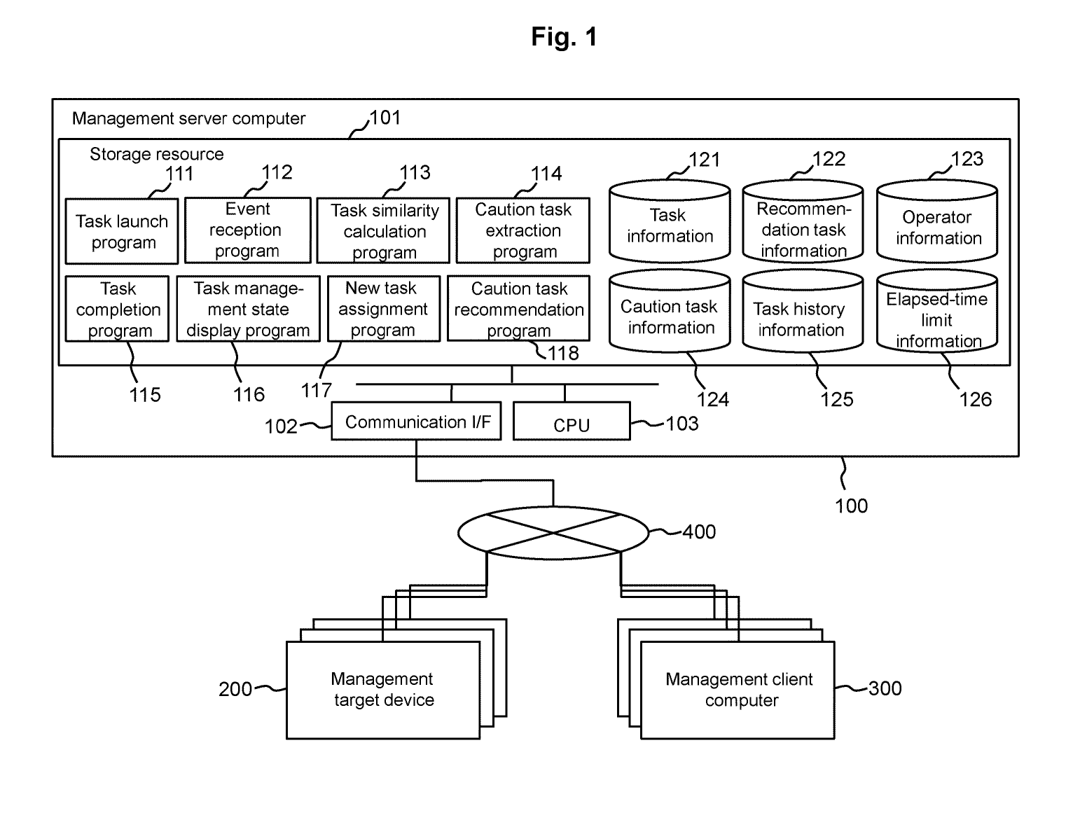

FIG. 1 is a configuration diagram of a client management system according to Embodiment 1.

The client management system denotes a system to manage computers and devices in the system and a client using these, and, when there arises a trouble, deal with the trouble. The client management system manages a task generated when performing client management, for example, assigns the task to an operator. The client management system includes a management server computer (referred to as “management server”) 100 as an example of a task management apparatus, one or more management client computers 300, one or more management target devices 200 and a communication network 400 such as a LAN (Local Area Network). The management server computer 100, the management client computers 300 and the management target devices 200 are coupled to each other via the communication network 400.

The management client computer 300 denotes a computer of a management target or a computer used by a client of a management target. For example, the management client computer 300 denotes a personal computer. The management target device 200 denotes a device of a management target or a device used by a client of a management target. For example, the management target device 200 denotes a printer or storage.

The management server 100 denotes a computer to manage the management client computer 300, the management target device 200 and a client using these. For example, the management server 100 denotes a general-purpose computer and includes a CPU (Central Processing Unit) 103, a storage resource 101, a communication I/F (interface) 102 and an input/output device (not shown). The storage resource 101 may denote a memory, a secondary storage device such as a hard disc drive (HDD) or a combination of the memory and the secondary storage device. The CPU 103, the storage resource 101 and the communication I/F 102 are coupled to each other via an internal bus.

The storage resource 101 stores a task launch program 111, an event reception program 112, a task similarity calculation program 113, a caution task extraction program 114, a task completion program 115, a task management state display program 116, a new task assignment program 117 and a caution task recommendation program 118. These programs 111 to 118 are executed by the CPU 103. Further, the storage resource 101 stores task information 121, recommendation task information 122, operator information 123, caution task information 124, task history information 125 and elapsed-time limit information 126. These items of information 121 to 126 will be described later with reference to the drawings.

The communication I/F 102 denotes an interface device to enable coupling to the communication network 400. The input/output device (not shown) denotes an interface device to enable coupling with an input/output device. For example, a display, a mouse or a keyboard is coupled to the input/output device. By displaying, on a display, various kinds of information required for client management or task management in the client management, the management server 100 can present a management state of the client management or the task management to a manager and accept a manager's instruction input from the mouse or the keyboard. It should be noted that the management server 100 may have the display.

The management server 100 manages a task generated when performing the client management. For example, the management server 100 performs processing such as new task assignment to an operator, caution task extraction and caution task recommendation. Specific processing content performed in the management server 100 will be described later with reference to the drawings.

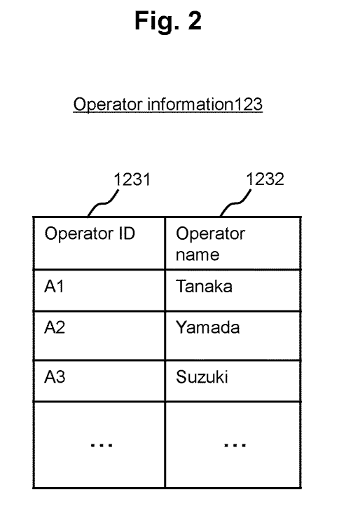

FIG. 2 is a diagram illustrating one example of operator information according to Embodiment 1.

The operator information 123 denotes information to manage an operator who executes a task. The operator information 123 includes an operator ID 1231 and an operator name 1232 as information items, for example. The operator ID 1231 stores an identifier to uniquely specify an operator. The operator name 1232 stores the name of an operator. By the operator information 123, operator identifiers and the names are managed in association with each other for each operator.

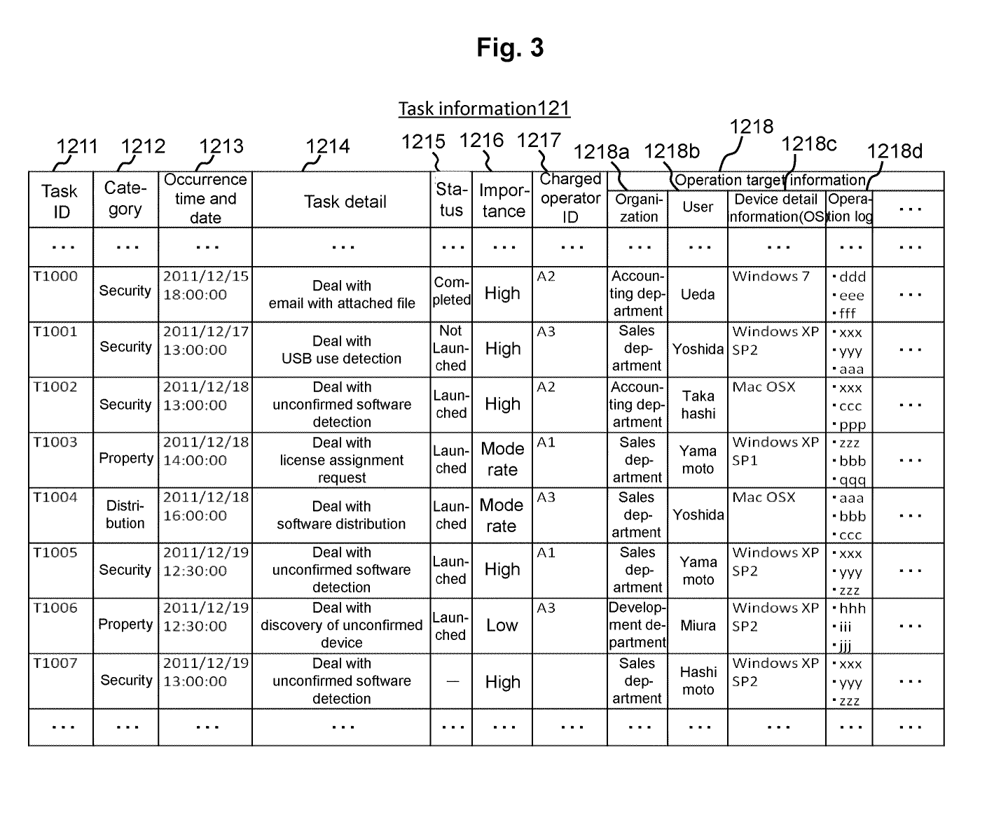

FIG. 3 is a diagram illustrating one example of task information according to Embodiment 1.

The task information 121 denotes information to manage a task generated when performing client management. The task information 121 includes task basic information (1211 to 1217) as information of tasks themselves and operation target information 1218 as information related to persons or objects of task targets. It should be noted that, in the present embodiment, as an object that can be a task target, the management target device 200 and the management client computer 300 are cited. Also, as a person who can be a task target, a user or manager of the management target device 200 or the management client computer 300 is cited.

The task basic information includes a task ID 1211, category 1212, an occurrence time and a date 1213, a task detail 1214, a status 1215, an importance 1216 and a charged operator ID 1217 as information items (i.e. task items). The task ID 1211 stores identifiers to uniquely specify tasks. The category 1212 stores categories to which the tasks belong. For example, the category 1212 stores “security” in the case of a task related to security and “distribution” in the case of a task related to software distribution. The occurrence time and date 1213 stores occurrence time and date of the tasks. The task detail 1214 stores content of the tasks. The status 1215 stores statuses of the tasks. For example, the status 1215 stores “completed” when task execution is completed, “launched” when a person in charge already starts executing a task, and “not launched” when the person in charge does not start executing the task yet. The importance 1216 stores information representing a task importance. For example, the importance 1216 stores “high” in the case of an important task, “low” in the case of an unimportant task, and “moderate” in the case of other tasks than an important or unimportant task. The charged operator ID 1217 stores the identifier of a charged operator, that is, an operator to whom a task is assigned.

The operation target information 1218 includes an organization 1218a, a user 1218b, a device detail information (OS) 1218c and an operation log 1218d as information items (i.e. task items). The organization 1218a stores the name of an organization to which a person or object of a task target belongs. The user 1218b stores the name of a person of a task target or the name of a user or manager of an object of a task target. The device detail information (OS) 1218c stores the name of an OS mounted on an object of a task target. The operation log 1218d stores a log of an operation performed for an object of a task target.

The task information 121 manages values of the above information items 1211 to 1218 of tasks for each of the tasks generated in the client management system. For example, according to the top row (record) of the task information 121 in FIG. 3, it is found that a task (hereinafter expressed as task “T1000”) having “T1000” as the task ID stored in the task ID 1211 is related to “security” and the task is generated at the time “2011/12/15 18:00:00,” and the task content is to “deal with an email with an attached file,” and the task is important. Also, it is found in the task “T1000” that a charged operator is an operator “A2” (i.e. an operator having “A2” as the operator ID 1231) and the task is already “completed,” that is, the execution is completed. Further, it is found in the task “T1000” that a user of a target object (e.g. the management client computer 300) of this task is “Ueda,” an organization to which the user “Ueda” belongs is an “accounting department,” an OS mounted on the target object of this task is “Windows 7,” and a log of an operation performed for the target object of this task is “• ddd • eee • fff.”

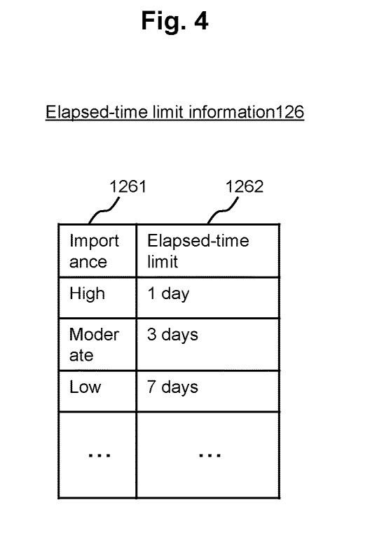

FIG. 4 is a diagram illustrating one example of elapsed-time limit information according to Embodiment 1.

The elapsed-time limit information 126 denotes information to manage reference time (i.e. elapsed-time limit) for a time period during which a non-launched state continues and which is used to determine an assigned task as a caution task. In the present embodiment, an assigned task in which the non-launched state exceeds the elapsed-time limit is determined as a caution task. The elapsed-time limit information 126 includes an importance 1261 and an elapsed-time limit 1262 as information items. The importance 1261 stores a task importance. In the present embodiment, the importance 1261 stores a value (“high,” “moderate” or “low”) configured to the importance 1216 of the task information 121. By the elapsed-time limit information 126, an elapsed-time limit for a task having an importance is managed for each task importance. In the example of FIG. 4, an elapsed-time limit for a task of an importance of “high” is one day, an elapsed-time limit for a task of an importance of “moderate” is three days, and an elapsed-time limit for a task of an importance of “low” is seven days.

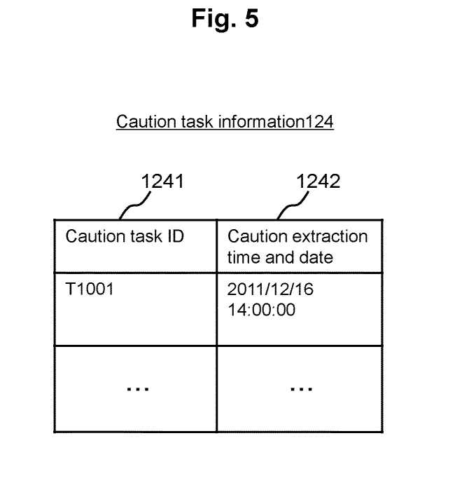

FIG. 5 is a diagram illustrating one example of caution task information according to Embodiment 1.

The caution task information 124 denotes information to manage a caution task. The caution task information 124 includes a caution task ID 1241 and caution extraction time and date 1242 as information items. The caution task ID 1241 stores a caution task identifier (i.e. task ID). An identifier configured to the caution task ID 1241 corresponds to a task ID stored in the task ID 1211 of the task information 121. That is, among tasks managed in the task information 121, a task ID of a task extracted as a caution task is stored in the caution task ID 1241. The caution extraction time and date 1242 stores the time and date at which the caution task is extracted. By the caution task information 124, a caution task and the time and date at which the caution task is extracted, are associated and managed.

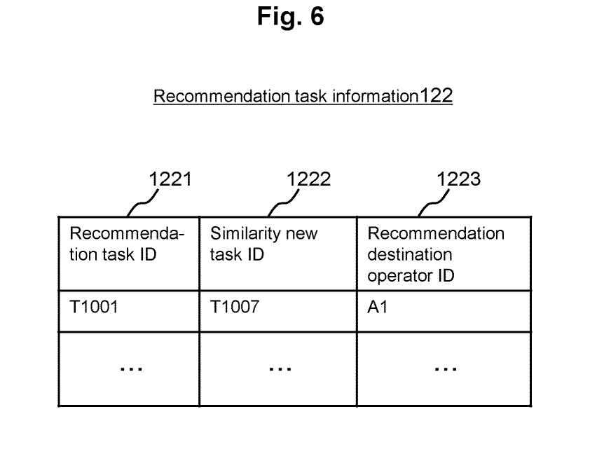

FIG. 6 is a diagram illustrating one example of recommendation task information according to Embodiment 1.

The recommendation task information 122 denotes information to manage a task (or recommendation task) recommended to be executed together with a new task for an operator to whom the new task is assigned, among caution tasks. The recommendation task information 122 includes a recommendation task ID 1221, a similarity new task ID 1222 and a recommendation destination operator ID 1223 as information items. The recommendation task ID 1221 stores the identifier of a recommendation task. The recommendation task ID 1221 corresponds to a task ID stored in the caution task ID 1241 of the caution task information 124 (i.e. task ID stored in the task ID 1211 of the task information 121). That is, the recommendation task ID 1221 of the recommendation task information 122 stores a task ID of a task recommended for an operator to whom a new task is assigned among caution tasks managed in the caution task information 124. The similarity new task ID 1222 stores the identifier of a new task similar to a recommendation task. The recommendation destination operator 1223 stores the identifier of a recommendation destination operator of a recommendation task.

The recommendation task information 122 manages recommendation tasks, recommendation destination operators of the recommendation tasks and new tasks which are similar to the recommendation tasks and which cause the recommendation tasks to be recommended, in association with each other. According to the top row (record) of the recommendation task information 122 in FIG. 6, it is found that the task “T1001” is similar to a new task “T1007” assigned to the operator “A1” and is therefore recommended to the operator “A1.”

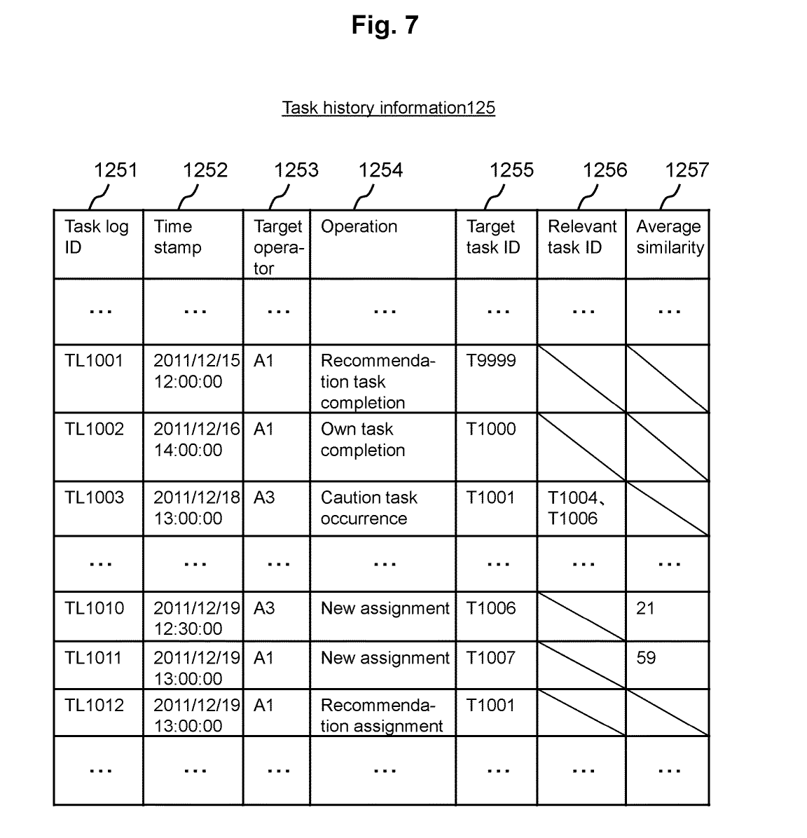

FIG. 7 is a diagram illustrating one example of task history information according to Embodiment 1.

The task history information 125 denotes information to manage a task management history. The task history information 125 manages a log (hereinafter referred to as “task log”) representing the content of each operation performed for task management. The task history information 125 includes a task log ID 1251, a time stamp 1252, a target operator 1253, an operation 1254, a target task ID 1255, a relevant task ID 1256 and an average similarity 1257 as information items. The task log ID 1251 stores the identifier to uniquely specify a task log. The time stamp 1252 stores the time and date at which an operation indicated by a task log is performed. The target operator 1253 stores the identifier of a target operator of an operation indicated by a task log. The operation 1254 stores content of an operation indicated by a task log. For example, the operation 1254 stores “new assignment” in the case of an assignment operation of a new task, “caution task occurrence” in the case of an extraction operation of a caution task, “recommendation assignment” in the case of a recommendation operation of a caution task, “own task completion” in the case of the completion of a task by a person in charge, and “recommendation task completion” in the case of the completion of a recommendation task by a recommendation destination operator. The target task ID 1255 stores the identifier of a target task of an operation indicated by a task log. The relevant task ID 1256 stores the identifier of a task launched by a person in charge of a caution task at the time the caution task is extracted. The average similarity 1257 stores the average similarity of tasks held by an operator to whom a new task is assigned, in a case where the new task is assigned. Here, the task average similarity denotes an average value of similarities between a plurality of tasks.

In the following, specific processing content performed by the management server 100 will be explained with reference to flowcharts.

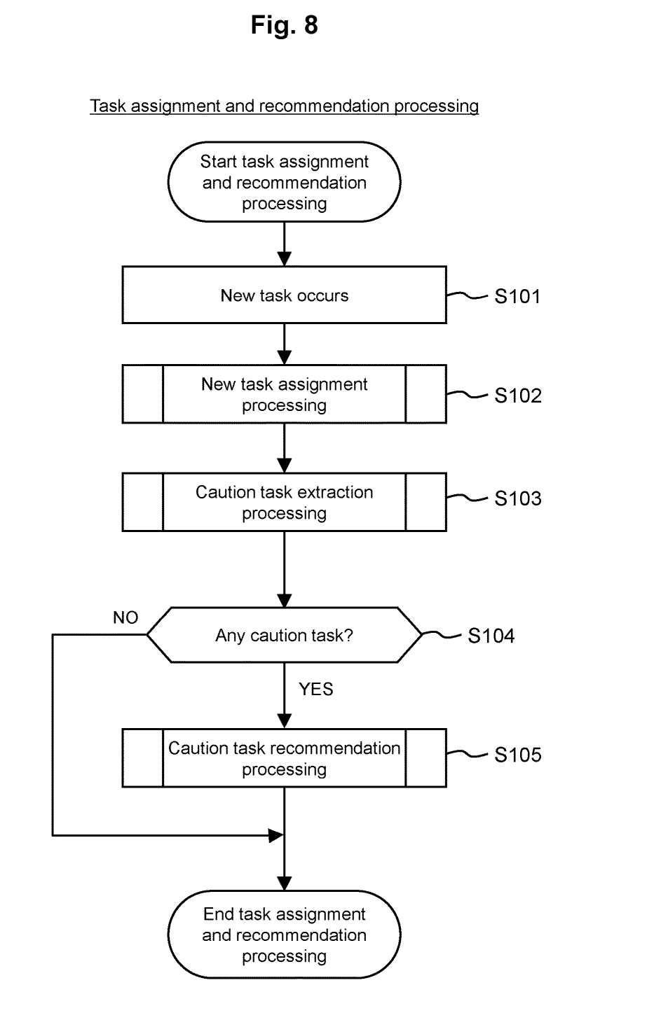

FIG. 8 is a flowchart of task assignment and recommendation processing according to Embodiment 1.

The task assignment and recommendation processing denote processing of assigning a new task to an operator, extracting a caution task and recommending a caution task. For example, the task assignment and recommendation processing starts at the timing the event reception program 112 of the management server 100 receives a notice that an event occurs from the management target device 200 or the management client computer 300.

When receiving the event, the event reception program 112 causes a new task to deal with the event and the new task assignment program 117 stores information related to the new task in the task information 121 (step S101). Here, in the task information 121, values of the status 1215 and the charged operator ID 1217 related to the new task may not be stored yet.

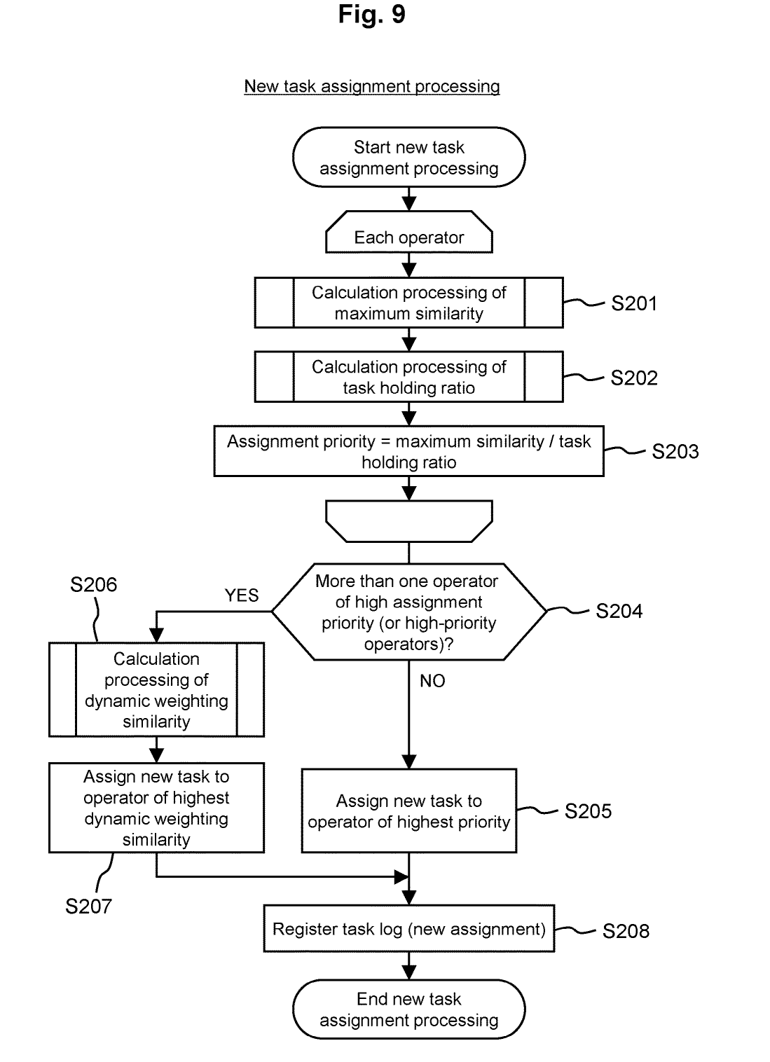

Next, the new task assignment program 117 performs assignment processing (see FIG. 9) of the new task (step S102). In the new task assignment processing, an operator to whom the new task is assigned stored in the task information 121 in step S101 is determined and the new task is assigned to the determined operator.

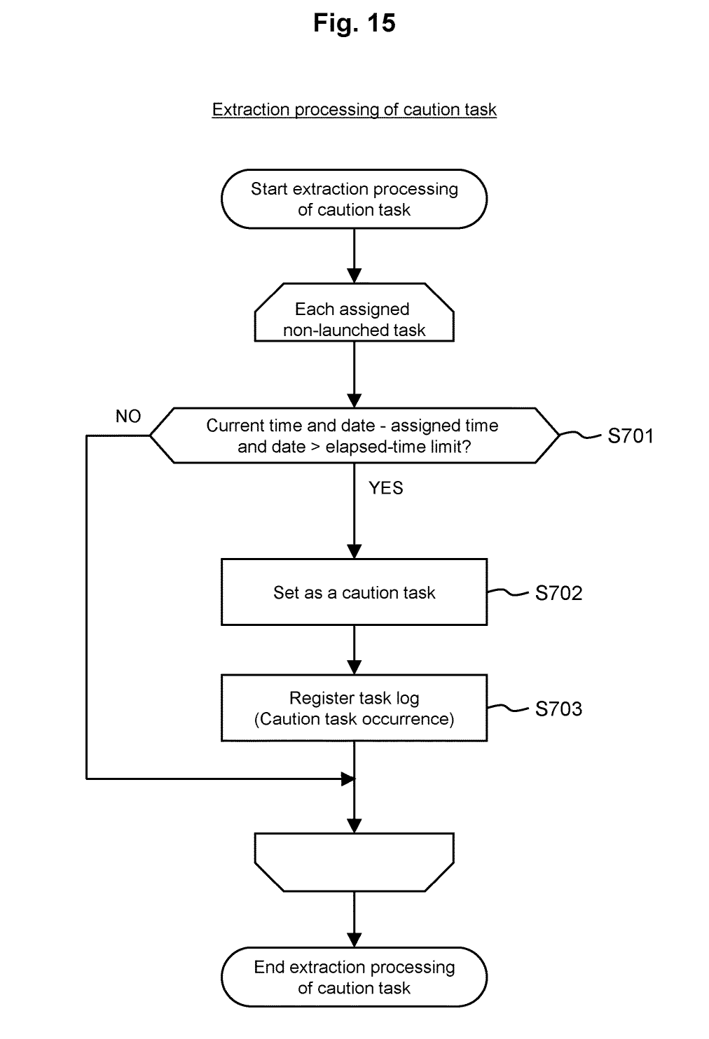

After the new task assignment processing is finished, the caution task extraction program 114 performs extraction processing (FIG. 15) of a caution task (step S103). In the caution task extraction processing, a caution task is extracted among tasks managed in the task information 121 with reference to the task information 121, the elapsed-time limit information 126 and the task history information 125.

After the caution task extraction processing is finished, the caution task recommendation program 118 determines whether there is any caution task (step S104). The caution task recommendation program 118 refers to the caution task information 124 and, when at least one caution task is managed, determines that there is a caution task. By contrast, when there is no caution task managed in the caution task information 124, the caution task recommendation program 118 determines that there is no caution task.

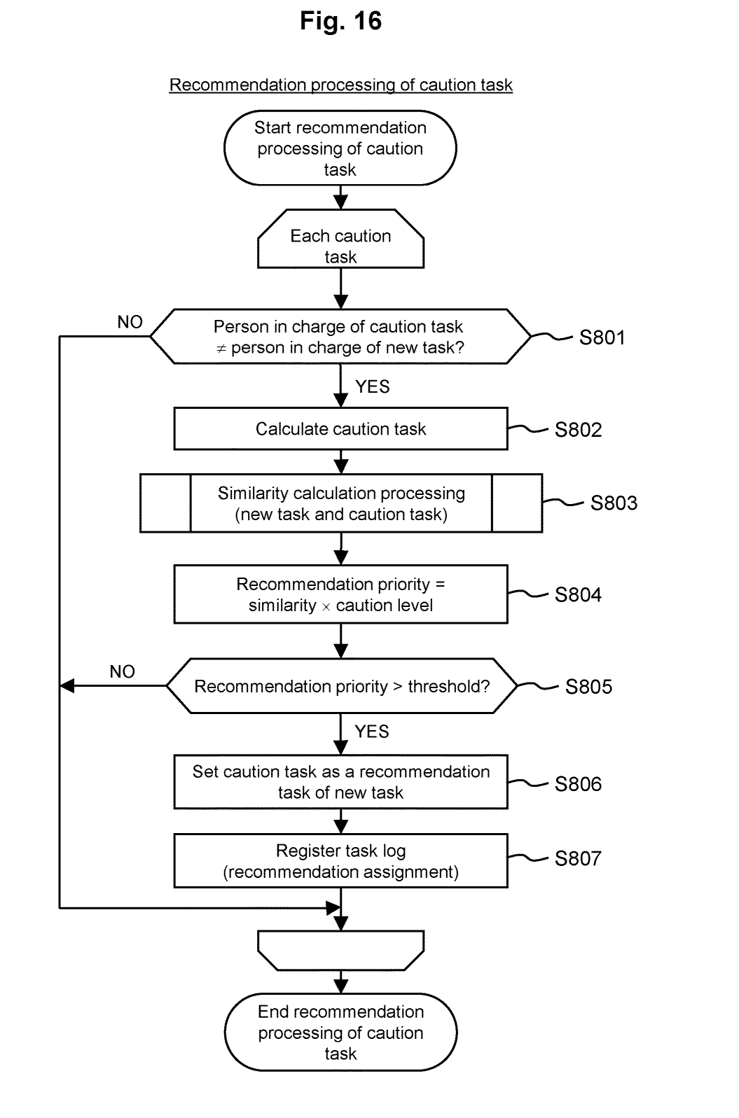

In a case where there is a caution task (step S104: YES), the caution task recommendation program 118 performs recommendation processing (see FIG. 16) of a caution task (step S105). In the caution task recommendation processing, it is determined whether to recommend a caution task to an operator to whom the new task is assigned stored in the task information 121 in step S102, and, if it is determined to recommend it, the caution task determined to be recommended is recommended to the operator to whom the new task is assigned. After the caution task recommendation processing is finished, the caution task recommendation program 118 ends the task assignment and recommendation processing.

By contrast, in a case where there is no caution task (step S104: NO), the caution task recommendation program 118 ends the task assignment and recommendation processing without performing caution task recommendation processing.

FIG. 9 is a flowchart of new task assignment processing according to Embodiment 1.

The new task assignment processing corresponds to the processing in step S102 of FIG. 8. The new task assignment processing is performed by the new task assignment program 117.

First, the new task assignment program 117 repeatedly performs processing in steps S201 to S203 for each of operators managed in the operator information 123. The new task assignment program 117 selects one of the operators managed in the operator information 123 (which is referred to as “target operator” in following steps S201 to S203).

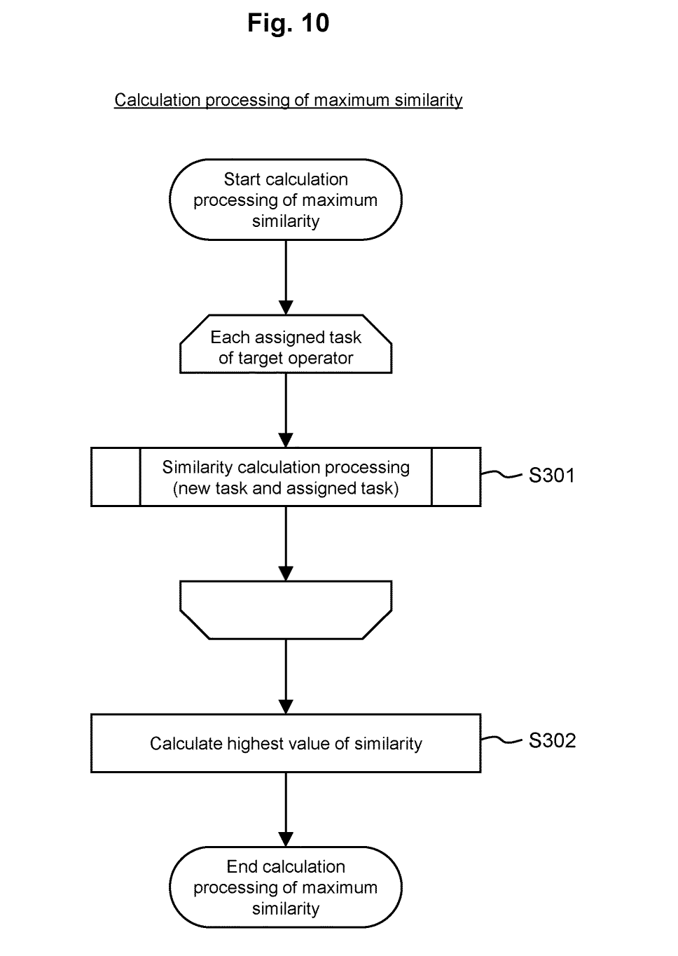

In step S201, the new task assignment program 117 causes maximum similarity calculation processing (see FIG. 10) of the target operator to be performed. In the maximum similarity calculation processing, the similarity is calculated between the new task and each of tasks that are already assigned to the target operator, that is, each of tasks held by the target operator, and the highest similarity among the calculated similarities is extracted as the maximum similarity of the target operator. It should be noted that, in the following explanation, the similarity between tasks may be referred to as “task similarity” and a task of the highest task similarity (i.e. maximum similarity) with a new task may be referred to as “maximum similarity task.” In the present embodiment, the task similarity has a value between 0 and 100%.

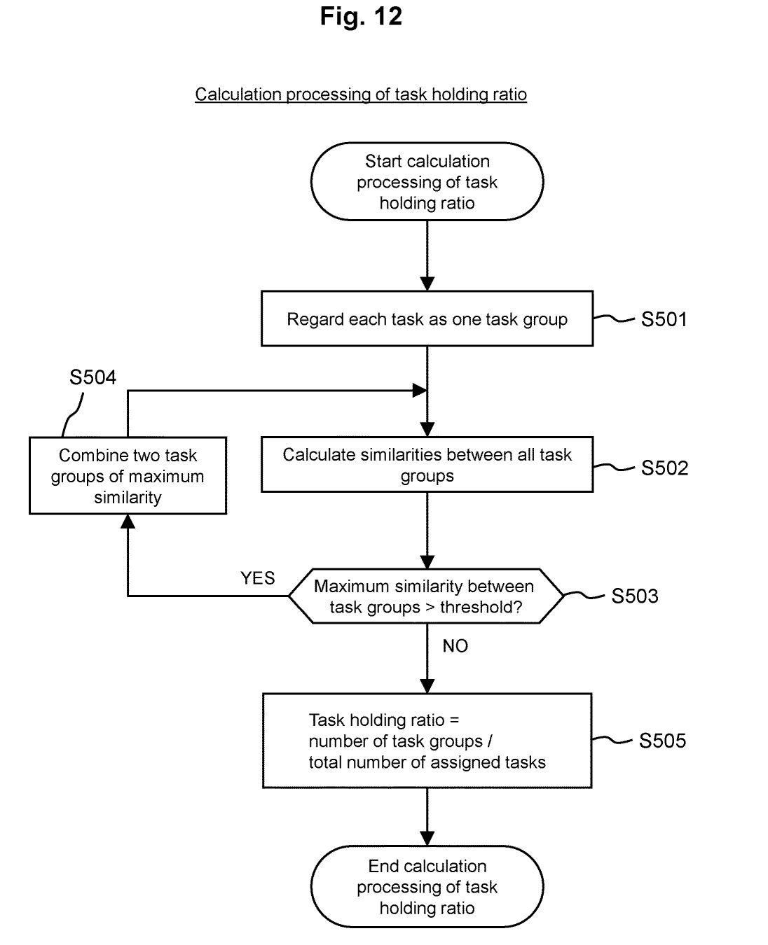

In step S202, the new task assignment program 117 performs calculation processing (see FIG. 12) of a task holding ratio of the target operator. In the task holding ratio calculation processing, a ratio of the number of tasks held by the target operator to the total number of tasks assigned to all operators, that is, the total number of assigned tasks, is calculated as a task holding rate of the target operator. It should be noted that, in the present embodiment, as described later, the number of tasks groups held by the target operator is adopted instead of the number of tasks held by the target operator.

In step S203, the new task assignment program 117 calculates the assignment priority of the target operator. Here, the assignment priority denotes a value as an index to determine to which operator the new task assignment is performed at the time of the assignment. For example, the assignment priority is calculated based on following [Equation 1.]

Assignment priority=maximum similarity/task holding ratio (Equation 1)

Equation 1 is defined such that higher assignment priority is assigned to an operator having higher maximum similarity, that is, an operator whose assigned task has higher task similarity to a new task, and an operator having a smaller number of assigned tasks. It should be noted that, in a case where there is no tasks, that is, in a case where the task holding ratio is 0%, the assignment priority of the operator is made the highest regardless of Equation 1. Therefore, in this case, a new task is preferentially assigned to the operator having no task.

By calculating the assignment priority based on Equation 1, the average similarity of tasks assigned to each operator becomes high and the task amount assigned to each operator is enhanced to be smoothed. Also, a new task is assigned to an operator of higher maximum similarity, and therefore the performance efficiency on tasks improves.

After processing in steps S201 to S203 is completed for each of the operators managed in the operator information 123, the new task assignment program 117 advances the process to step S204.

In step S204, the new task assignment program 117 determines whether there are a plurality of operators for which the assignment priority calculated in step S203 is high (hereinafter referred to as “high priority operator”). Here, high assignment priority means not only that the value is absolutely high but also that the value is relatively high among assignment priorities of the plurality of operators. For example, based on a predetermined first threshold (hereinafter referred to as “dynamic weighting execution threshold”), whether there are a plurality of high priority operators is determined as follows. That is, first, an operator (hereinafter referred to as “top priority operator”) having the maximum value of assignment priority (hereinafter referred to as “priority maximum value”) is counted as one of high priority operators. Here, if there are a plurality of operators having the priority maximum value, it means that there are a plurality of high priority operators. Also, it is determined whether there is any operator having priority close to the priority maximum value in addition to the top priority operators, the operator having the assignment priority close to this priority maximum value is counted as a high priority operator. Here, whether the assignment priority is close to the priority maximum value is determined based on whether the assignment priority is within a range between the priority maximum value and the dynamic weighting execution threshold, and, in a case where it is within the range, it is determined to be close. Therefore, in a case where there are a plurality of operators having assignment priority within a range between the priority maximum value and the dynamic weighting execution value (including the priority maximum value), the new task assignment program 117 can determine that there are a plurality of high priority operators. Meanwhile, in a case where there is only one operator (who is the top priority operator) having assignment priority within a range between the priority maximum value and the dynamic weighting execution value (including the priority maximum value), the new task assignment program 117 can determine that a plurality of high priority operators are not present.

In a case where a plurality of high priority operators are not present (step S204: NO), the new task assignment program 117 determines an operator having the maximum assignment priority, that is, a top priority operator as an operator to whom a new task is assigned, and assigns a new task to the operator (S205). Here, the new task assignment program 117 stores “not launched” in the status 1215 corresponding to a new task in the task information 121, stores the identifier of the top priority operator in the charged operator ID 1217 and reports the assigned new task to the management client computer 300 of the operator to whom a task is assigned.

After that, the new task assignment program 117 stores, in the task history information 125, a task log showing that the new task assignment is performed (step S208). To be more specific, the task history information 125 stores the task log storing the time and date at which a new task is assigned in the time stamp 1252, storing the identifier of an operator to whom a task is assigned in the target operator 1253, storing “new assignment” in the operation 1254, storing the identifier of the new task in the target task ID 1255 and storing, in the average similarity 1257, the average similarity of tasks held by the operator to whom a task is assigned at that time. After that, the new task assignment program 117 ends the new task assignment processing.

Meanwhile, in step S204, in a case where a plurality of high priority operators are present (step S204: YES), the new task assignment program 117 causes calculation processing of dynamic weighting similarity to be performed (step S206). In the dynamic weighting similarity calculation processing, a weight is calculated for each task item of the task information 121 and the dynamic weighting similarity is calculated taking into account the weights in the task similarity between the maximum similarity task of a high priority operator and a new task for each high priority operator.

After that, the new task assignment program 117 determines an operator in which the dynamic weighting similarity calculated in step S206 is the highest, as a new task assignee, and assigns the new task to the operator (step S207). Here, the new task assignment program 117 stores “not launched” in the status 1215 corresponding to a new task in the task information 121, stores the identifier of an operator to whom the new task is assigned, in the charged operator ID 1217, and reports the assigned new task to the management client computer 300 of the operator to whom a task is assigned. After that, the new task assignment program 117 stores, in the task history information 125, a task log indicating that the new task assignment is performed (step S208), and ends the new task assignment processing.

According to the above processing, assignment priority is calculated for each operator and a new task is assigned to an operator having the highest assignment priority. Meanwhile, in a case where there are a plurality of operators having high assignment priority, dynamic weighting similarity is calculated taking into account the weight of each task item and a new task is assigned to an operator having the highest dynamic weighting similarity. In the present embodiment, high assignment priority, in some cases, high assignment priority and dynamic weighting similarity are references to determine an assignee, but the references to determine an assignee are not limited to these. For example, based on the task history information 125, the performance efficiency of each operator or the assumed processing time to process a new task is calculated, and, in addition to assignment priority and dynamic weighting similarity, the calculated performance efficiency or the assumed processing time may be taken into account to determine an assignee. Also, in the case of intentionally controlling an assignee for every operator for reasons such as an educational purpose, filtering may be performed before assignment. That is, a new task meeting a predetermined condition may be assigned to a predetermined operator regardless of the above processing.

FIG. 10 is a flowchart of maximum similarity calculation processing according to Embodiment 1.

The maximum similarity calculation processing corresponds to the processing in step S201 in FIG. 9. In the maximum similarity calculation processing, the task similarity between each of tasks held by a target operator and a new task is calculated and the maximum similarity having the maximum value among the calculated task similarities is calculated.

First, the task similarity calculation program 113 repeatedly performs the processing in step S301 for each of tasks held by the target operator at the current time. The task similarity calculation program 113 selects one of the tasks held by the target operator (which will be referred to as “target task” in following step S301).

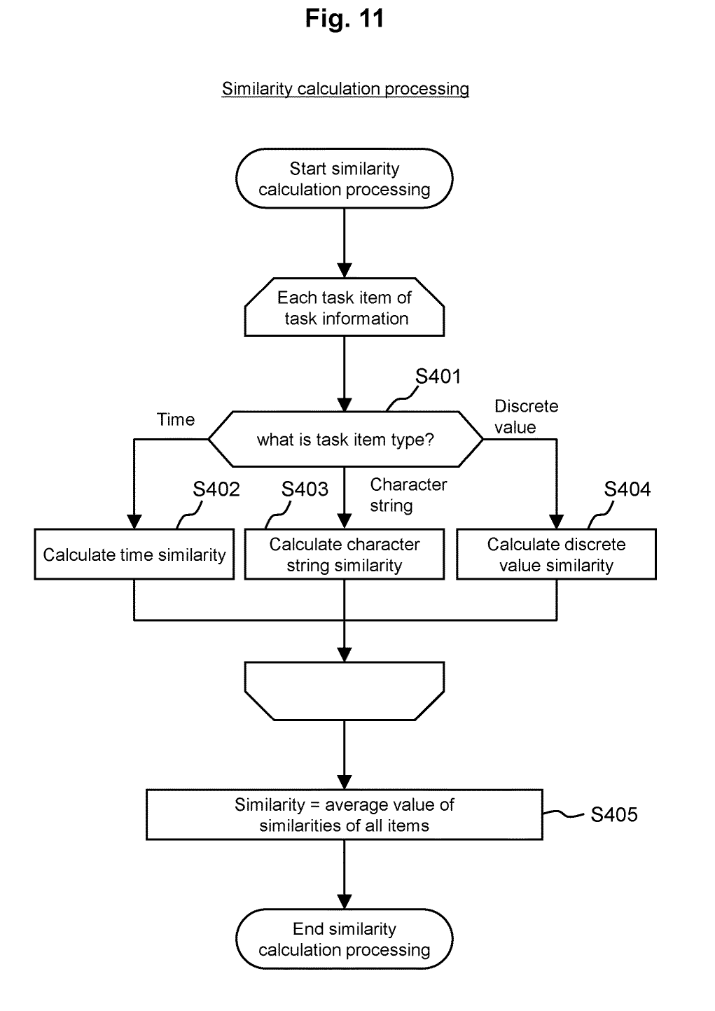

In step S301, the task similarity calculation program 113 performs similarity calculation processing (see FIG. 11) and calculates the task similarity between the target task and a new task.

After the processing in step S301 is completed for all the tasks held by the target operator, the task similarity calculation program 113 advances the process to step S302.

In step S302, the new task assignment program 117 extracts task similarity of the highest value from the task similarities calculated for the tasks held by the target operator, as the maximum similarity of the target operator. After that, the new task assignment program 117 ends the maximum similarity calculation program.

It should be noted that, in the present embodiment, although the task similarity between a new task and each of tasks held by a target operator at the current time is calculated as a candidate of maximum similarity selection, it is not necessarily limited to this. For example, in addition to the tasks held by the target operator at the current time, the task similarity between a new task and a task, which has been previously executed and in which assignment is already cancelled, may also be calculated as a candidate of maximum similarity selection.

FIG. 11 is a flowchart of similarity calculation processing according to Embodiment 1.

The similarity calculation processing denotes processing of calculating the task similarity between two tasks, and corresponds to the processing in step S301 of FIG. 10 and the processing in step S803 of FIG. 16.

First, the task similarity calculation program 113 repeatedly performs the processing in steps S401 to S404 for each of the task items of the task information 121. The task similarity calculation program 113 selects one of the task items (which will be referred to as “target task item” in following steps S401 to S404). It should be noted that, in the following explanation, the similarity between tasks with respect to one task item may be referred to as “item similarity.”

In step S401, the task similarity calculation program 113 determines which of “time,” “character string” and “discrete value” (i.e. selection value) a type of the target task item is. For example, in the case of the task information 121 illustrated in FIG. 3, the time and date 1213 is classified into “time,” and the task detail 1214, the device detail information (OS) 1218c and the operation log 1218d are classified into “character string.” Other task items that the above, that is, the task ID 1211, the category 1212, the status 1215, the importance 1216, the charged operator ID 1217, the organization 1218a and the user 1218b are information items whose values are selected from a plurality of selection values, and are therefore classified into the discrete value.

In a case where a type of the target task item is “time” (step S401: time), the task similarity calculation program 113 calculates the item similarity with respect to the target item according to following Equation 2 (step S402). Here, Equation 2 is defined such that, when the time difference between the target task items of two tasks is “0,” the item similarity is “100” and becomes smaller (i.e. becomes closer to “0”) when the time difference between the target task items of the two tasks becomes larger.

Item similarity of “time”=100/(|time difference between task items of tasks|+1) (Equation 2)

Meanwhile, when a type of the target task item is “character string” (step S401: character string), the task similarity calculation program 113 extracts terms by morphological analysis, calculates the ratio of terms common in information of the target task items of both tasks among all terms, and provides the calculated ratio as the item similarity with respect to the target task items. It should be noted that the item similarity of “character string” may be calculated using an N-gram method or a calculation method of edit distance.

Meanwhile, in a case where a type of the target task item is “discrete value” (step S401: discrete value), the task similarity calculation program 113 calculates the item similarity with respect to the target task item, based on a rule that “the item similarity is set to “100” in a case where the item values of the two tasks are matched, and the item similarity is set to “0” in a case where the item values of the two tasks are not matched” (step S404). It should be noted that the semantic content of selection values configured to the task items may be taken into account and weighted to individually define an arbitrary value from “0” to “100.” Also, regarding task items such as the organization 1218a, taking into account the distance between organizations based on the organization layer structure, the item similarity with respect to “discrete value” may be calculated.

After the processing in step S401 to S404 is completed for all task items, the task similarity calculation program 113 advances the process to step S405.

In step S405, the task similarity calculation program 113 calculates an average value of item similarities of all task items. The calculated average value is set as the task similarity between the two tasks. After that, the task similarity calculation program 113 ends the similarity calculation processing.

FIG. 12 is a flowchart of calculation processing of a task holding ratio according to Embodiment 1.

The task holding ratio calculation processing corresponds to the processing in step S202 of FIG. 9. For example, the task holding ratio calculation processing is performed by the new task assignment program 117.

Here, the task holding ratio can be calculated based on, for example, following Equation 3, but, in the present embodiment, as shown in following Equation 4, the number of task groups is used as a value of the numerator of Equation 3 instead of using the number of tasks held by a target operator as is. That is, by a hierarchical-type clustering method using task similarity as distance, the tasks held by the target operators are clustered and the number of finally-obtained clusters (i.e. the number of task groups) is used as a value of the numerator to calculate the task holding ratio.

Task holding ratio=number of tasks held by target operator/total number of tasks assigned to all operators (Equation 3)

Task holding ratio=number of task groups held by target operator/total number of task groups assigned to all operators (Equation 4)

First, the new task assignment program 117 regards each of tasks held by the target operator as one cluster (hereinafter referred to as “task group”) (step S501).

In step S502, the new task assignment program 117 calculates the task similarities between all task groups. Here, regarding the task similarity between two certain task groups A and B, for example, the task similarities between tasks in the task group A and tasks in the task group B are calculated, and the average value, minimum value or maximum value of the calculated task similarities can be provided as the task similarity between task groups A and B. It should be noted that the task similarity can be calculated by the similarity calculation processing shown in FIG. 11.

After that, the new task assignment program 117 determines whether the maximum value of the task similarities between the task groups calculated in step S502 is higher than a predetermined second threshold (hereinafter referred to as “task group decision threshold”) (step S503).

In a case where the maximum value of the task similarities between the task groups is higher than the task group decision threshold (step S503: YES), the new task assignment program 117 combines two task groups having the maximum task similarity as one task group (step S504). After that, the new task assignment program 117 advances the process to step S502.

Meanwhile, in a case where the maximum value of the task similarities between the task groups is equal to or smaller than the task group decision threshold (step S503: NO), the new task assignment program 117 calculates a task holding ratio based on Equation 4 (step S505). After that, the new task assignment program 117 ends the task holding ratio calculation processing.

Thus, in the present embodiment, by applying the hierarchical-type clustering method using task similarity as distance, similar tasks are regarded as one task group and the task group number is used to calculate a task holding ratio by Equation 4. By this means, taking into account that it is possible to efficiently process similar tasks at once, it is possible to calculate a task holding ratio distinguishing operator's burdens between the case of holding a plurality of similar tasks and the case of holding a plurality of non-similar tasks.

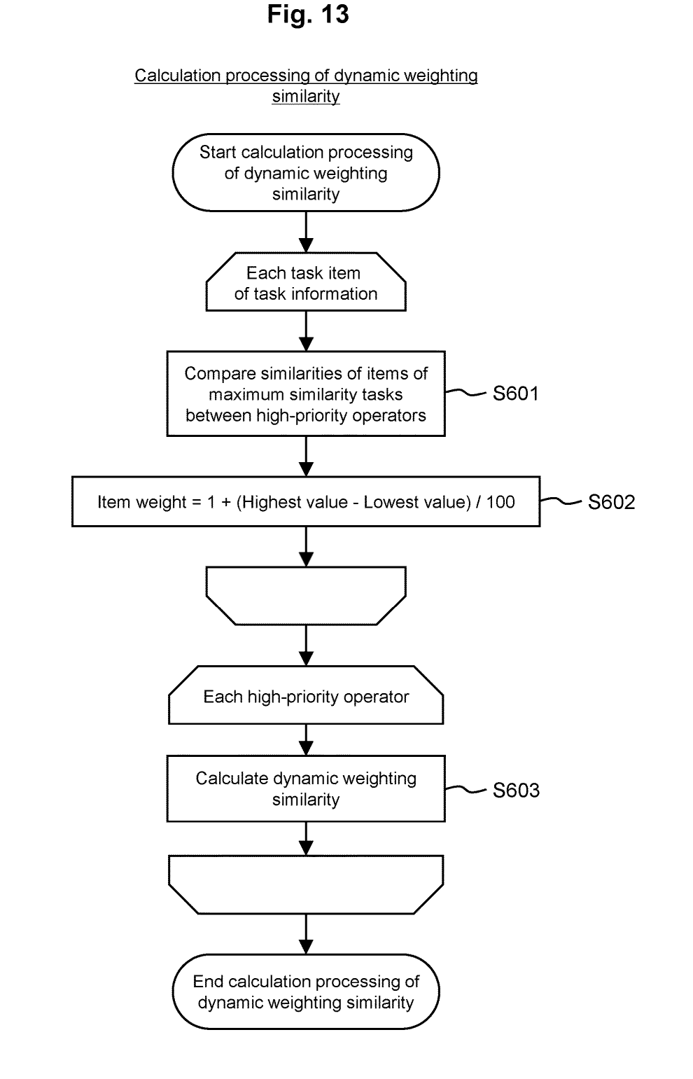

FIG. 13 is a flowchart of calculation processing of dynamic weighting similarity according to Embodiment 1.

The dynamic weighting similarity calculation processing corresponds to the processing in step S206 of FIG. 9. First, the new task assignment program 117 performs the processing in steps S601 and S602 for each of task items. The new task assignment program 117 selects one of the task items (which will be referred to as “target task item” in following steps S601 and S602).

In step S601, between high priority operators, the new task assignment program 117 compares the item similarities with respect to the target task item between the maximum similarity task and a new task, and extracts the maximum value and minimum value of the item similarities with respect to the target task item.

In step S602, the new task assignment program 117 calculates a weight of the target task item by following Equation 5, based on the item similarity maximum and minimum values extracted in step S601. Here, Equation 5 is defined such that the weight becomes larger in the case of a task item having a higher item similarity difference between the high priority operators. Therefore, by using this weight, it is possible to calculate task similarity (or dynamic weighting similarity) reflecting an influence of a task item having a larger item similarity difference.

Task item weight=1+(maximum value of item similarity−minimum value of item similarity)/100 (Equation 5)

After the processing in steps S601 and S602 is completed for all task items, the new task assignment program 117 repeatedly performs processing in step S603 for each of the high priority operators. The new task assignment program 117 selects one of the high priority operators (which will be referred to as “target high-priority operator” in following step S603).

In step S603, the new task assignment program 117 calculates the dynamic weighting similarity of the target high-priority operator, that is, similarity taking into account the task item weight calculated in step S602 for the task similarity between the maximum similarity task of the target high-similarity operator and a new task. Although this dynamic weighting similarity calculation processing is basically the same as the similarity calculation processing in FIG. 11, in steps S402, S403 and S404 in FIG. 11, the results of multiplying the item similarities calculated in these steps by the target task item weight are provided as the item similarities.

After the processing in step S603 is completed for all the high priority operators, the new task assignment program 117 ends the dynamic weighting similarity calculation processing.

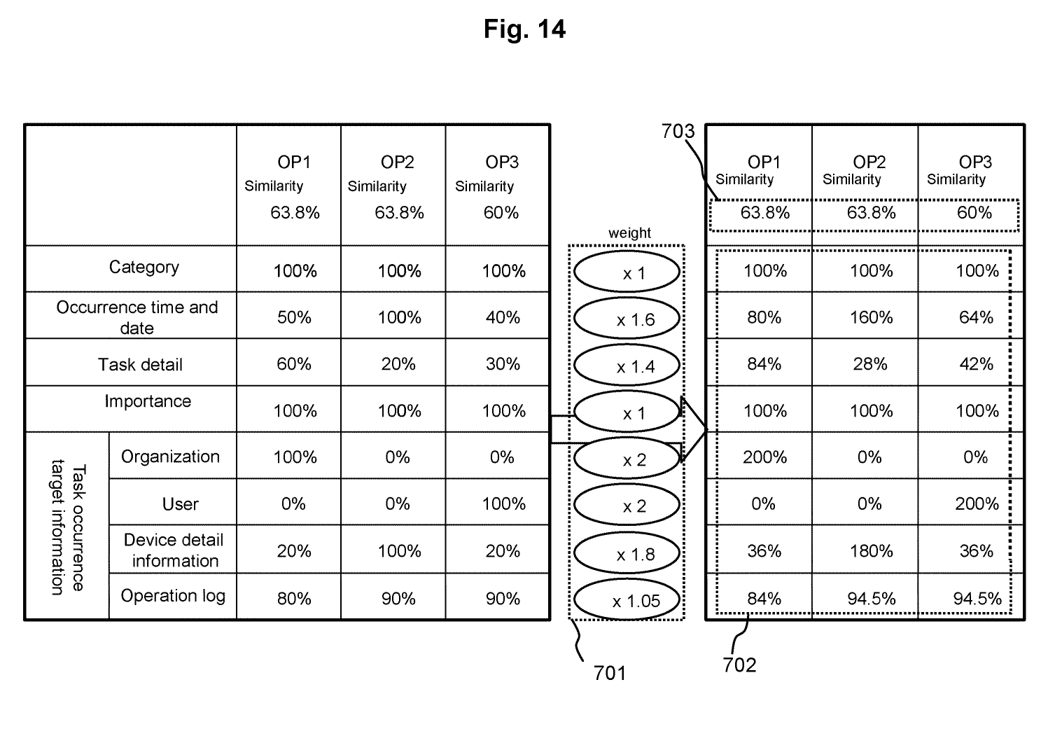

FIG. 14 is a diagram which specifically illustrates dynamic weighting similarity calculation processing according to Embodiment 1.

In this example, there are operators 1 (OP1), operator 2 (OP2) and operator 3 (OP3) as high priority operators.

First, for each task item, by above Equation 5, weights 701 of task items are calculated. For example, regarding “category,” the item similarities of all operators are 100%, and therefore their maximum values and minimum values are 100%. Therefore, by above Equation 5, the weight of “category” is “1.” Also, regarding “organization,” the item similarity of the operator 1 is 100% and the item similarities of the operators 2 and 3 are 0%. Therefore, by above Equation 5, the weight of “organization” is “2.” Regarding other task items, similarly, by above Equation 5, the weights are calculated using the maximum values and the minimum values of the item similarities. By such weight calculation, the weight of “category,” in which there is little difference between the item similarities of the operators, is “1” and minimum, and the weights of “organization” and “user,” in which the difference between the item similarities of the operators is the largest, are “2” and maximum.

After the weights 701 with respect to all task items are calculated, an item similarity (hereinafter referred to as “weighting item similarity”) 702 taking into account the weights are calculated for each of task items of each high priority operator. For example, regarding the operator 1, the item similarity of “category” is 100% and the weight of “category” is “1,” and therefore the weighting item similarity of “category” is 100% (=100% x1). Also, the item similarity of “time and date” is 50% and the weight of “time and date” is “1.6,” and therefore the weighting item similarity of “time and date” is 80% (=50%×1.6). Regarding other task items, similarly, the item similarities of the task items and the weights are multiplied to calculate the weighting item similarities.

After the weighting item similarity 702 is calculated for all task items of the high priority operators, dynamic weighting similarity 703 of each high priority operator is calculated. To be more specific, for each of the high priority operators, the average value of the weighting item similarities of all task items is calculated. This calculated average value is used as the dynamic weighting similarity 703 of the high priority operator. For example, regarding the operator 1, 85.5% is used as the dynamic weighting similarity 703, which is an average value of the weighting item similarities of all task items (i.e. 100% of “category,” 80% of “time and date,” 84% of “task detail,” 100% of “importance,” 200% of “organization,” 0% of “user,” 36% of “device detail information” and 84% of “operation log”). According to this dynamic weighting similarity calculation processing, it is possible to calculate the dynamic weighting similarities reflecting an influence of task items having a larger item similarity difference.

FIG. 15 is a flowchart of caution task extraction processing according to Embodiment 1.

The caution task extraction processing corresponds to the processing in step S103 of FIG. 8.

First, the caution task extraction program 114 repeatedly performs the processing in steps S701 to S703 for each of tasks (or non-launched tasks) that are not executed by a person in charge yet among the tasks managed in the task information 121. The caution task extraction program 114 selects one of the non-launched tasks (which will be referred to as “target non-launched task” in following steps S701 to S703). It should be noted that, in the present embodiment, among the tasks managed in the task information 121, tasks in which “not launched” is configured in the status 1215 denote the non-launched tasks.

In step S701, with reference to the task information 121, the elapsed-time limit information 126 and the task history information 125, the caution task extraction program 114 obtains the time and date at which the target non-launched task is assigned and an elapsed-time limit of the target non-launched task. Then, the caution task extraction program 114 determines whether the time difference between the current time and date and the time and date at which the target non-launched task is assigned (i.e. a time period during which the target non-launched task is non-launched) is over the elapsed-time limit corresponding to the target non-launched task. It should be noted that the elapsed-time limit of the target non-launched task denotes an elapsed-time limit corresponding to the importance of the target non-launched task and is obtained by searching the elapsed-time limit information 126 using, as a key, the importance of the target non-launched task obtained from the task history information 125.

In a case where the time difference between the current time and date and the time and date at which the target non-launched task is assigned is over the elapsed-time limit corresponding to the target non-launched task (step S701: YES), the caution task extraction program 114 sets the target non-launched task as a caution task (S702). That is, the caution task extraction program 114 associates and stores the identifier of the target non-launched task and the current time and date corresponding to the time and date at which the target non-launched task is extracted as a caution task, in the caution task information 124.

After that, the caution task extraction program 114 stores a task log indicating that the target non-launched task is extracted as a caution task, in the task history information 125 (step S703). To be more specific, the task history information 125 stores the task log storing the time and date at which the caution task is extracted in the time stamp 1252, storing the identifier of a person in charge of the caution task in the target operator 1253, storing “caution task occurrence,” in the operation 1254, storing the identifier of the caution task in the target task ID 1255 and storing, in the relevant task ID 1256, the identifier of a task that is currently launched by a person in charge of the caution task.

Meanwhile in step S701, in a case where it is determined that the time difference between the current time and date and the time and date at which the target non-launched task is assigned is not over the elapsed-time limit related to the target non-launched task (step S701: NO), the caution task extraction program 114 does not perform the processing in steps S702 and S703. That is, the caution task extraction program 114 does not set the target non-launched task as a caution task.

After the processing in steps S701 to S703 is completed for all non-launched tasks, the caution task extraction program 114 ends the caution task extraction processing.

FIG. 16 is a flowchart of caution task recommendation processing according to Embodiment 1.

The caution task recommendation processing corresponds to the processing in step S105 of FIG. 8.

First, the caution task recommendation program 118 repeatedly performs the processing in step S801 to S807 for each of caution tasks managed in the caution task information 124. The caution task recommendation program 118 selects one of the caution tasks (which will be referred to as “target caution task” in following steps S801 to S807).

In step S801, the caution task recommendation program 118 determines whether a charged operator of the target caution task differs from a charged operator of a new task. It should be noted that the new task in this caution task recommendation processing denotes a new task assigned to an operator in step S102 of FIG. 8. Therefore, the charged operator of the new task denotes an operator to whom the new task is assigned in step S102 of FIG. 8 before this caution task recommendation processing is performed.

In a case where the charged operator of the target caution task differs from the charged operator of the new task (step S801: YES), the caution task recommendation program 118 calculates the caution level of the target caution task based on following Equation 6. Here, Equation 6 is defined such that the caution level becomes “1” at the timing a caution task is extracted, and simply increases as time elapses in the state of “non-launched.”

Caution level=(elapsed time since caution task was assigned)/(elapsed-time limit of caution task) (Equation 6)

Next, the caution task recommendation program 118 causes similarity calculation processing (see FIG. 11) to be performed and obtains the task similarity between the new task and the target caution task calculated by the similarity calculation processing (step S803).

After that, based on the caution level calculated in step S802 and the task similarity obtained in step S803, the caution task recommendation program 118 calculates recommendation priority of the target caution task by following Equation 7 (step S804). Here, the recommendation priority denotes a value as an index to determine whether to recommend execution of the caution task to the operator to whom the new task is assigned.

Recommendation priority=task similarity×caution level (Equation 7)

After that, the caution task recommendation program 118 determines whether the target caution task recommendation priority calculated in step S804 is higher than a predetermined third threshold (hereinafter referred to as “recommendation priority threshold”) (step S805). Here, the recommendation priority threshold denotes a threshold as a reference to determine whether to recommend the target caution task to an operator.

In a case where the target caution task recommendation priority is higher than the recommendation priority threshold (step S805: YES), the caution task recommendation program 118 sets the target caution task as a recommendation task to recommend it to be executed by the operator in charge of the new task (step S806). That is, the caution task recommendation program 118 associates and stores the identifier of the target caution task, the identifier of the new task and the identifier of the person in charge of the new task in the recommendation task information 122, and reports a recommendation task to the management client computer 300 of a corresponding operator.

After that, the caution task recommendation program 118 stores a task log indicating that the target caution task is set as a recommendation task, in the task history information 125 (step S807). In this task log, the time stamp 1252 configures the time and date at which the recommendation task is recommended, the target operator 1253 configures the identifier of the recommendation destination operator, the operation 1254 configures “recommendation assignment” and the target task ID 1255 configures the identifier of the recommendation task.

Meanwhile, in step S801, in a case where the operator in charge of the target caution task is the same as the operator in charge of the new task (step S801: NO), the caution task recommendation program 118 does not perform the processing in steps S802 to S807. That is, the caution task recommendation program 114 does not set the target caution task as a recommendation task.

Also, in step S805, in a case where it is determined that the recommendation priority of the target caution task is equal to or smaller than the recommendation priority threshold (step S805: NO), the caution task recommendation program 118 does not perform the processing in steps S806 and S807. That is, the caution task recommendation program 118 does not set the target caution task as a recommendation task.

After the processing in steps S801 to S807 are completed for all caution tasks, the caution task recommendation program 118 ends the caution task recommendation processing.

As described above, by determining, based on recommendation priority multiplying task similarity and a caution level, whether to perform recommendation for a person in charge of a new task, it is possible to preferentially recommend a caution task, which has high task similarity with the new task and in which elapsed time is long in a non-launched state, to an operator (in the present embodiment, an operator in charge of the new task) different from an actual charged operator. Also, by adopting a system to recommend a caution task to the operator in charge of the new task at the time of assignment of the new task, it is possible to suppress a processing load compared to the case of taking into account combinations of the caution task and all existing tasks. It should be noted that, since assignment based on task similarity is already done at the time of assignment of the new task, it is useful to eliminate the process of determining an assignee by recalculating task similarities between the caution task and the existing tasks because such a process is no longer effective.

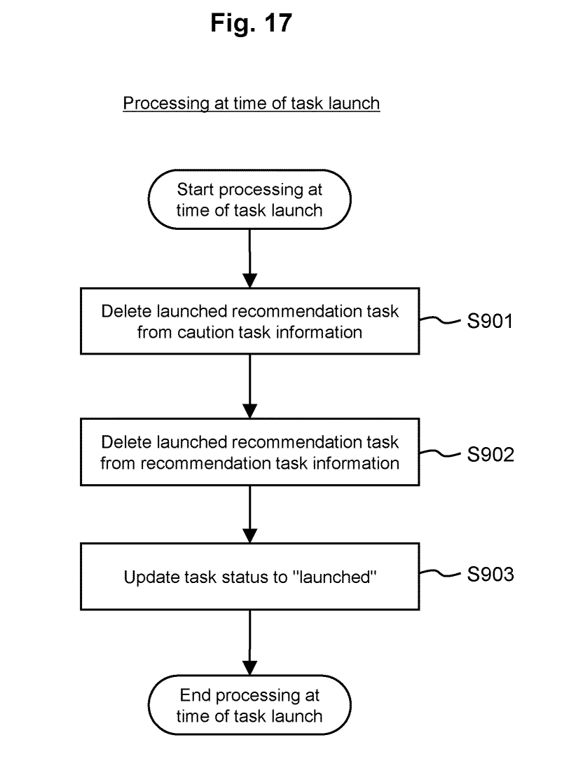

FIG. 17 is a flowchart of processing at the time of task launch according to Embodiment 1.

The processing at the time of task launch denotes processing performed in a case where an operator to whom execution of a caution task is recommended starts executing the recommended caution task (i.e. recommendation task). First, the task launch program 111 deletes information (row) corresponding to the recommendation task (or caution task) which has been executed, from the caution task information 124 (step S901). For example, information that the recommendation task has been executed, is transmitted based on an operator's input with respect to the management client computer 300 of the operator, from the management client computer 300.

Next, the task launch program 111 deletes the information (row) corresponding to the recommendation task that has been executed, from the recommendation task information 122 (step S902).

After that, the task launch program 111 changes a value of the status 1215 corresponding to the recommendation task that has been executed, to “launched,” in the task information 121 (step S903). After that, the task launch program 111 ends the processing at the time of task launch.

As described above, in a case where a recommendation destination operator starts executing a recommendation task, by changing the state corresponding to the recommendation task to “launched,” an operator in charge of the recommendation task can know that the recommendation task is executed by another operator and needs not be processed by the charged operator.

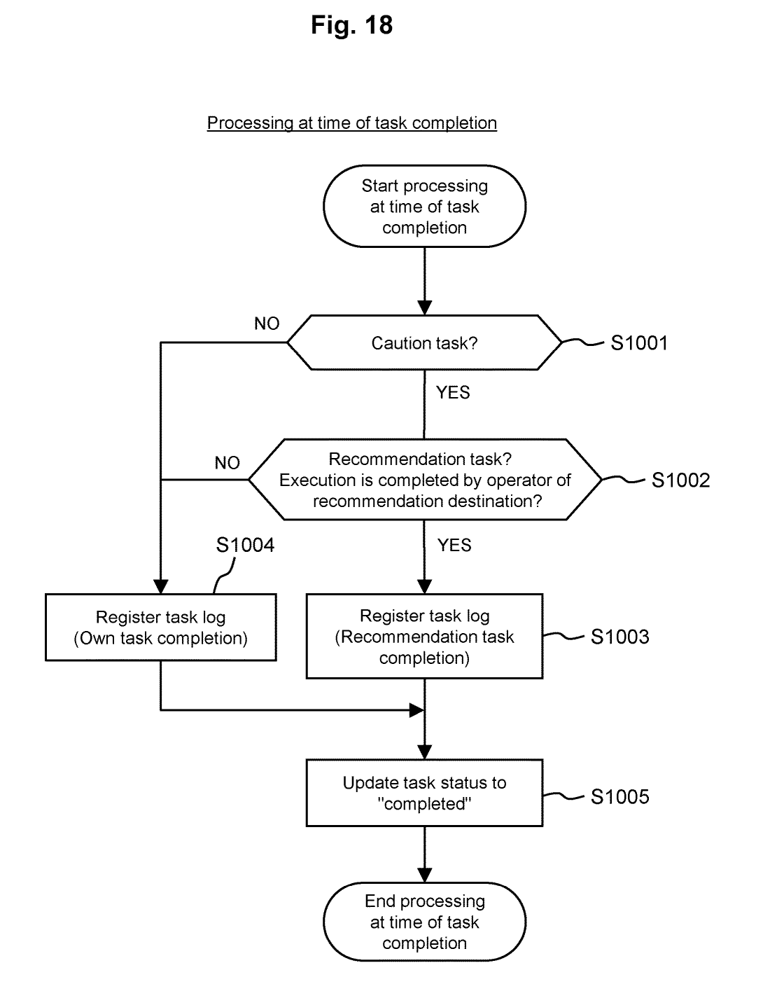

FIG. 18 is a flowchart of processing at the time of task completion according to Embodiment 1.

The processing at the time of task completion denotes processing performed in a case where task execution is completed. For example, the processing at the time of task completion is performed by the task completion program 115.

First, the task completion program 115 determines whether a completed task is a caution task (step S1001). For example, information that task execution is completed, is transmitted based on an operator's input with respect to the management client computer 300 of the operator, from the management client computer 300.

In a case where the completed task is the caution task (step S1001: YES), the task completion program 115 determines whether the completed task is a recommendation task and a recommendation destination operator completes execution of the recommendation task (step S1002). Whether it is the recommendation task can be determined based on the recommendation task information 122.

In a case where the completed task is the recommendation task and the recommendation destination operator completes execution of the recommendation task (step S1002: YES), the task completion program 115 stores a task log indicating that the recommendation destination operator completes execution of the recommendation task, in the task history information 125 (step S1003). In this task log, the time stamp 1252 stores the time and date at which the task was completed, the target operator 1253 stores the identifier of the recommendation destination operator, the operation 1254 stores “recommendation task completion” and the target task ID 1255 stores the identifier of the completed task.

Meanwhile, in step S1001, in a case where it is determined that the completed task is not the caution task (step S1001; NO) or where it is determined that the completed task is not the recommendation task or the recommendation destination operator does not complete execution of the recommendation task, that is, the charged operator completed execution of the recommendation task (step S1002: NO), the task completion program 115 stores a task log indicating that the task execution is completed by the charged operator, in the task history information 125 (step S1004). In this task log, the time stamp 1252 stores the time and date at which the task was completed, the target operator 1253 stores the identifier of a person in charge of the task, the operation 1254 stores “own task completion” and the target task ID 1255 stores the identifier of the completed task.

After that, the task completion program 115 changes a value of the status 1215 related to the completed task, to “completed,” in the task information 121 (step S1005). After that, the task completion program 115 ends the processing at the time of task completion.

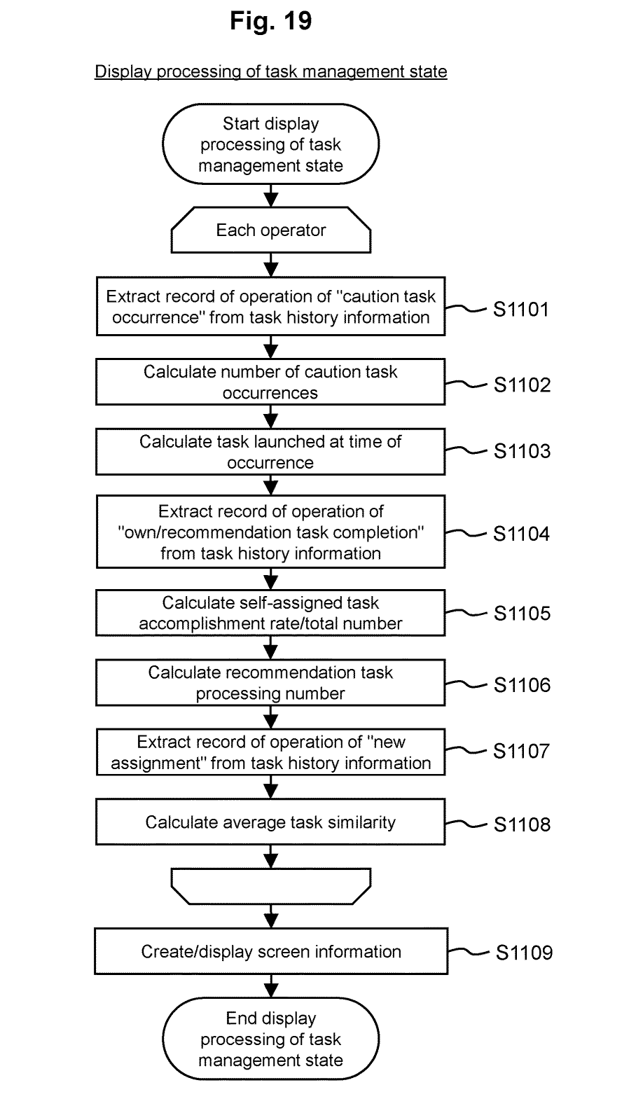

FIG. 19 is a flowchart of display processing of a task management state according to Embodiment 1.

The task management state display processing denotes processing of crating statistical information for a certain period of time such as a month and a week, based on the task history information 125, and displaying the created statistical information.

First, the task management state display program 116 repeatedly performs the processing in steps S1101 to S1108 on each of operators managed in the operator information 123. The task management state display program 116 selects one of the operators (which will be referred to as “target operator” in following steps S1101 to S1108) managed in the operator information 123.

In step S1101, the task management state display program 116 extracts a task log (or record) in which a value of the operation 1254 is “caution task occurrence,” from the task history information 125.

Next, the task management state display program 116 refers to the task log extracted in step S1101 and calculates the occurrence number of caution tasks with respect to the target operator (step S1102).

Also, the task management state display program 116 refers to the task log extracted in step S1101 and the task information 121, and, with respect to the target operator, calculates the ratio of launched tasks by category at the time of occurrence of a caution task (step S1103). Further, the task management state display program 116 extracts a task log in which a value of the operation 1254 is “own task completion” or “recommendation task completion,” from the task history information 125 (step S1104).

After that, the task management state display program 116 refers to the task log extracted in step S1104 and, with respect to the target operator, calculates the total number of tasks that have been executed among assigned tasks (hereinafter referred to as “total number”) and the ratio of the number of tasks that have been executed by a charged operator alone, to the total number (hereinafter referred to as “accomplishment rate”) (step S1105). Also, the task management state display program 116 refers to the task log extracted in step S1104 and calculates the processing number of recommendation tasks with respect to the target operator (step S1106).

Further, the task management state display program 116 extracts a task log in which a value of the operation 1254 is “new assignment,” from the task history information 125 (step S1107).

After that, the task management state display program 116 refers to the task log extracted in step S1107 and calculates average task similarity with respect to the target operator (step S1108). Here, the average task similarity denotes an average value of extracted average similarities 1257.

After the processing in steps S1101 to S1108 is completed for all operators managed in the operator information 123, the task management state display program 116 advances the process to the step S1109.

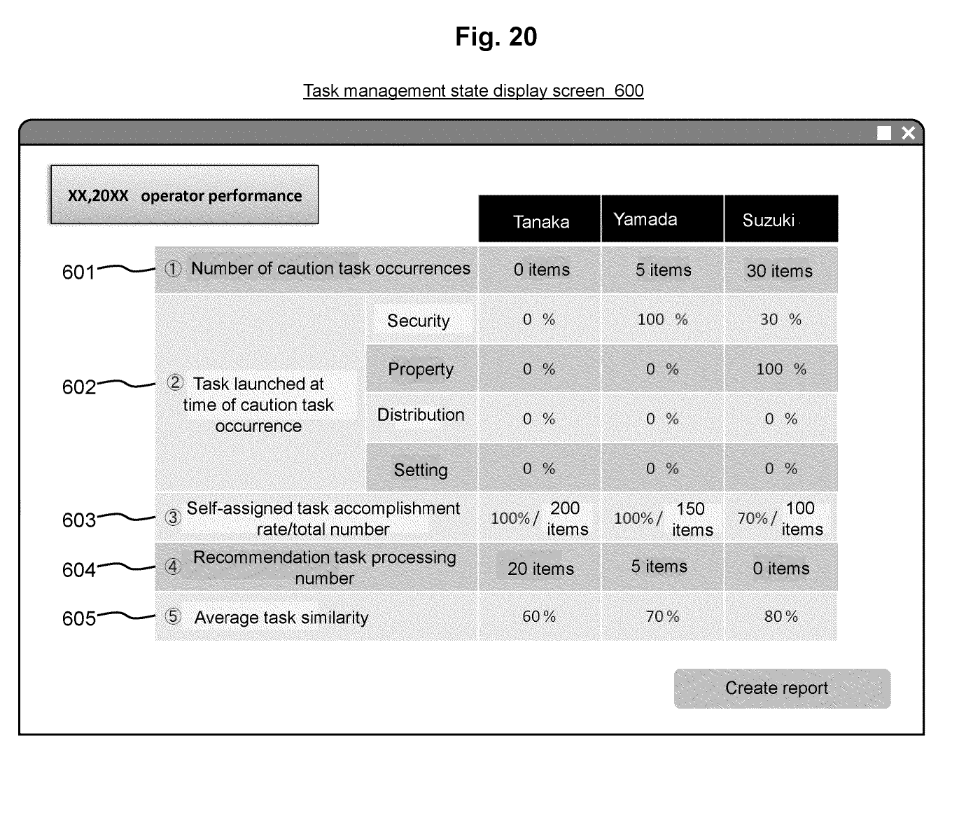

In step S1109, the task management state display program 116 displays task management state display screen 600 (see FIG. 20) including information obtained in steps S1102, S1103, S1105, S1106 and S1108, on a display coupled to the management server 100. After that, the task management state display program 116 ends the task management state display processing.

FIG. 20 is a diagram illustrating one example of a task management state display screen according to Embodiment 1.

For each of operator, the task management state display screen 600 is provided with: an area 601 configured to display the occurrence number of caution tasks; an area 602 configured to display the ratio of launched tasks by category at the time of occurrence of the caution tasks; an area 603 configured to display the accomplishment rate and the total number; an area 604 configured to display the processing number of recommendation tasks; and an area 605 configured to display average task similarity.

The area 601 displays the occurrence number of caution tasks calculated by the display processing of the task management state. Also, the area 602 displays a ratio of launched tasks by category at the time of occurrence of the caution tasks calculated by the display processing of the task management state. Also, the area 603 displays the accomplishment rate and the total number calculated by the display processing of the task management state. Also, the area 604 displays the processing number of recommendation tasks calculated by the display processing of the task management state. Also, the area 605 displays the average task similarity calculated by the display processing of the task management state.

It should be noted that, in addition to or instead of the information displayed in the areas 601 to 605, for example, the occurrence number of caution tasks for each department or time slot may be displayed. Also, average similarity of generated tasks for each department or time slot may be displayed. Also, it may be possible to tally these items of information over time and display them using a graph or the like.

The information displayed in the areas 601 to 604 is used as determination criteria to implement the following actions. For example, based on the occurrence number of caution tasks displayed in the area 601, it is possible to adaptively adjust the number of operators according to the occurrence number of caution tasks as a whole. For example, in a case where many caution tasks occur for almost all of operators, it is possible to take measures of increasing the number of operators, while, if a state continues where a caution task hardly occurs, it is possible to take measures of decreasing the number of operators. By this means, it is possible to optimize labor costs.

Also, for example, based on the occurrence number of caution tasks displayed in the area 601 and the ratio of launched tasks by category at the time of occurrence of caution tasks, which is displayed in the area 602, it is possible to provide advice on operational improvement to an operator for which especially many caution tasks occur.

Also, for example, based on the ratio of launched tasks by category at the time of occurrence of caution tasks, which is displayed in the area 602, a task of category which is likely to be launched at the time of occurrence of caution tasks, can be determined as a task that is hard for the operator, that is, a task that tends to require time. Therefore, based on this information, in a case where it is found that a task of specific category tends to be hard, it is possible to implement a countermeasure of providing education related to the category. By this means, it is possible to streamline operations and reduce operational time. It should be noted that, instead of each category, calculation may be performed for each importance or occurrence source organization.

Also, for example, based on the accomplishment rate and the total number displayed in the area 603 and the processing number of recommendation tasks displayed in the area 604, operations are efficiently executed, and it is possible to specify an operator having high contribution on operations (i.e. operator who has executed many assigned tasks and recommendation tasks) and share the know-how. By this means, it is possible to streamline operations and reduce operational time.

Also, for example, based on the average task similarity displayed in the area 605, in view of operation records such as the average task similarity of assigned tasks and the number of caution tasks, it is possible to find the operator's performance efficiency and take measures such as change of position and education. For example, it is possible to find an operator who has many caution tasks and low performance efficiency regardless of high similarity of assigned tasks, and provide skill improvement by education or the like. By this means, it is possible to streamline operations and reduce operational time.

Also, for example, in a case where the occurrence number of caution tasks for each department or time slot is displayed, based on this information, it is possible to find a tendency that other tasks are likely to remain while a task of specific organization or time slot is launched, and check a cause. Based on this information, for example, a tendency that a task is likely to remain while a certain department launches a license management operation, may be checked. Also, as a result of checking its cause, in a case where it is clarified that it is caused by the fact that the department does not understand license management from the inside out, it is possible to take measures of implementing edification. By this means, it is possible to specify the root cause and reduce operator's operational time.

Also, for example, in a case where the average similarity of generated tasks for each department or time slot is displayed, based on this information, regarding departments and time slots, it is possible to find a tendency that similar tasks locally occur, and it is possible to take measures. For example, it is possible to find a tendency that many tasks associated with prohibited software installation occur at the beginning of period, and it is possible to take measures of implementing edification in time for the period. By this means, it is possible to specify the root cause and reduce operator's operational time.

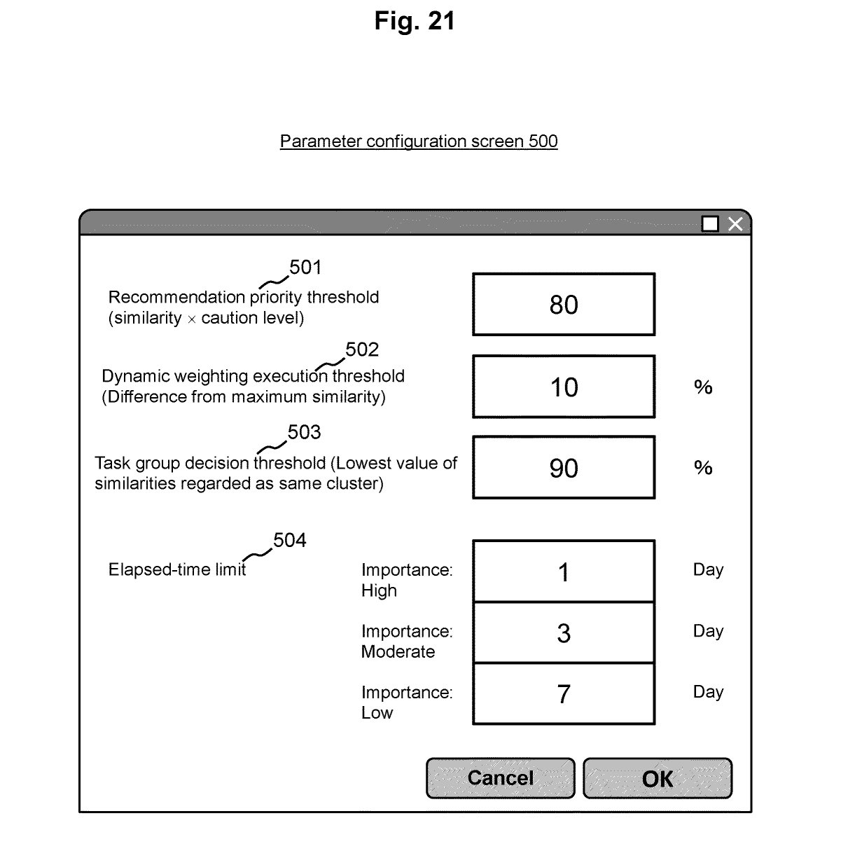

FIG. 21 is a diagram illustrating one example of a parameter configuration screen according to Embodiment 1.

A parameter configuration screen 500 denotes a screen to display various parameters to be referred to when performing various kinds of processing for task management in the management server 100, such that a manager configures them. For example, the parameter configuration screen 500 is displayed on a display coupled to the management server 100 or a display of the management client computer 300 of the manager.

As illustrated in FIG. 21, the parameter configuration screen 500 is provided with: an area 501 configured to configure a recommendation priority threshold; an area 502 configured to configure a dynamic weighting execution threshold; an area 503 configured to configure a task group decision threshold; and an area 504 configured to configure an elapsed-time limit for each importance. The manager can configure these various parameters using an input device.

According to the client management system according to above Embodiment 1, it is possible to determine a task similarity taking into account operation target information and improve the accuracy of task similarity determination. Also, it is possible to enhance the accuracy of similarity determination used to determine a task assignee, and therefore it is possible to assign a task to a more suitable operator, which results in improving the performance efficiency. Also, since the performance efficiency with respect to tasks improves, it is possible to systematically implement task assignment of cross-sectional operation and execute operations efficiently with less number of operators. Also, by performing caution task extraction processing and caution task recommendation processing, it is possible to prevent assigned tasks from remaining as a non-launched state for a long time, and, at the same time, another recommended operator can complete the remaining task without feeling a heavy burden. Further, by finding the task remaining state, it is further possible to optimize the number of operators.

### Embodiment 2

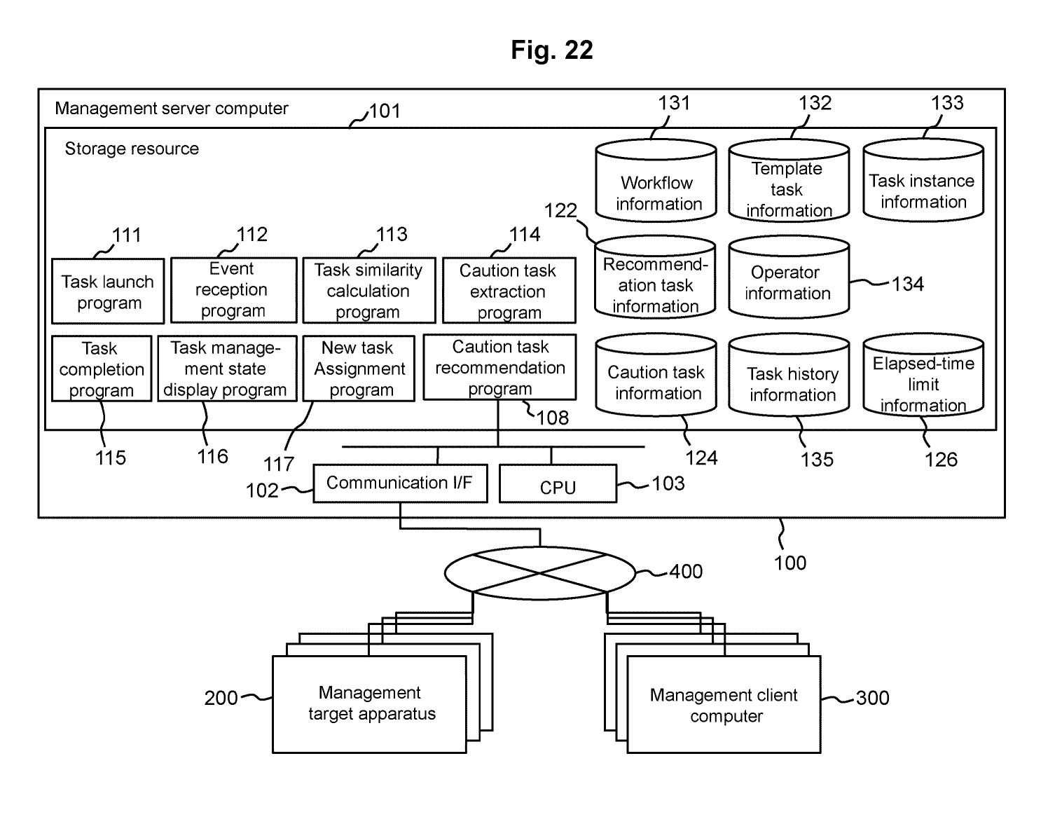

FIG. 22 is a configuration diagram of a workflow management system according to Embodiment 2.

The workflow management system according to Embodiment 2 denotes a system of managing tasks executed according to a workflow. The tasks executed according to the workflow includes an automatic task executed by a computer instead of a human, in addition to a task (referred to as “manual task” in Embodiment 2) executed by an operator (i.e. human) as described above. Therefore, a task in Embodiment 2 does not necessarily denote an operation performed by human, and means one of a manual task and an automatic task. The workflow management system performs assignment with respect to a manual task operator of a management target, taking into account an performance efficiency on tasks.

A structure of the workflow management system is substantially the same as the structure of the client management system in FIG. 1, except for partial components. The same reference numerals are assigned to the same components in FIG. 1 and their explanation will be omitted.

In the workflow management system, the management server 100 manages tasks. For example, with respect to manual tasks, the management server 100 performs processing of assigning a task to an operator, extracting a caution task and recommending a caution task. The storage resource 101 of the management server 100 stores workflow information 131, template task information 132 and task instance information 133. Also, the storage resource 101 stores operator information 134 instead of the operator information 123 and task history information 135 instead of the task history information 125.

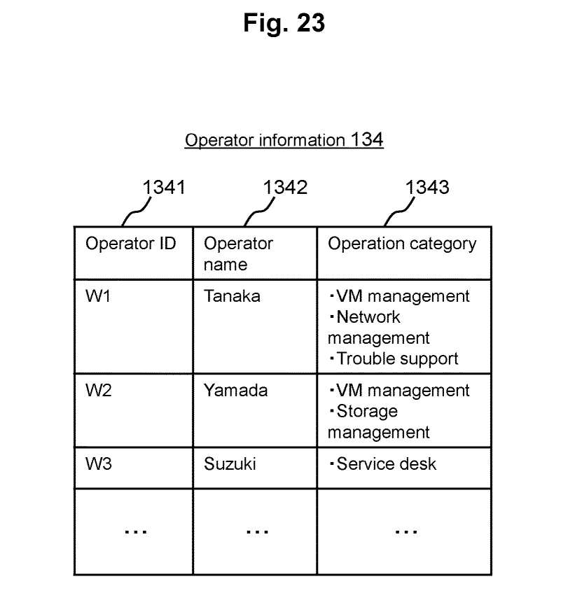

FIG. 23 is a diagram illustrating one example of operator information according to Embodiment 2.

The operator information 134 denotes information to manage an operator who executes a task. An operator ID 1341 and an operator name 1342 are actually equivalent to the operator ID 1231 and the operator name 1232 in the operator information in FIG. 2.

The operator information 134 further includes an operation category 1343 as an information item. The operation category 1343 stores a task category that can be processed by an operator. According to the top row (record) of the operator information 134, it is found that, for example, an operator named “Tanaka” having “W1” as the operator ID 1341 can process tasks belonging to one of “VM management,” “network management” and “trouble support.”

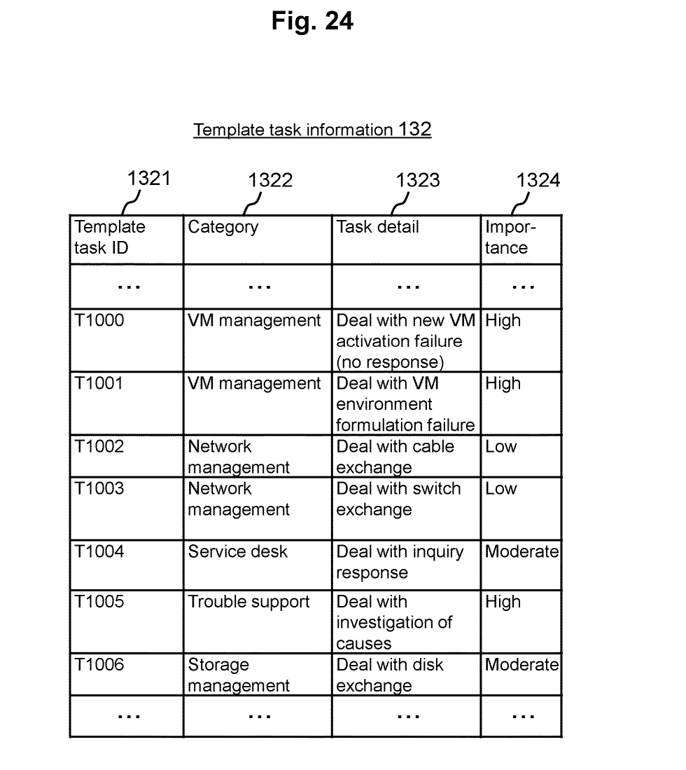

FIG. 24 is a diagram illustrating one example of template task information according to Embodiment 2.

The template task information 132 denotes information to manage template tasks corresponding to tasks defined by information that can be defined in advance (e.g. task-belonging category, task importance and task content) among the task basic information. The template task information 132 includes a template task ID 1321, a category 1322, a task detail 1323 and an importance 1324 as information items. The template task ID 1321 stores an identifier to uniquely specify a template task. The category 1322, the task detail 1323 and the importance 1324 are substantially the same as the category 1212, the task detail 1214 and the importance 1216 in the task information 121 in FIG. 3, respectively. These information items 1321 to 1324 denote information that can be defined in advance before a task occurs, unlike information specified at the time of task occurrence (e.g. task occurrence date and time, task state, task charged-person identifier and operation target information).

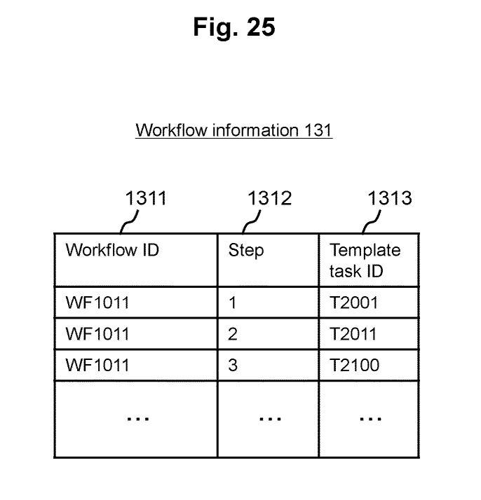

FIG. 25 is a diagram illustrating one example of workflow information according to Embodiment 2.

The workflow information 131 denotes information to manage a workflow which is defined by a combination of template tasks and which is a task sequence to achieve a certain object. The workflow information 131 includes a workflow ID 1311, a step 1312 and a template task ID 1313 as information items. The workflow ID 1311 stores an identifier to uniquely specify a workflow. The step 1312 stores the order at which a task in a workflow is executed. The template task ID 1313 stores a template task identifier.

The workflow information 131 includes at least one combination data (i.e. record) of values of the information items 1311, 1312 and 1313. One record means that, in a workflow indicated by the workflow ID 1311, a template task of the template task ID 1313 is executed in the order in the step 1312. In the example of the workflow information 131 in FIG. 25, the first-row record means that, in a workflow having a workflow ID of “WF1011” (hereinafter referred to as “workflow ‘WF1011’”). A template task having a template task ID of “T2001” (hereinafter referred to as “template task ‘T2001’”) is executed in the first order. Also, the second-row record combination data means that, in the workflow “WF1011,” a template task “T2011” is executed in the second order. Further, the third-row record means that, in the workflow “WF1011,” a template task “T2100” is executed in the third order. By this means, it is possible to find that the workflow “WF1011” is a task sequence having the template task “T2001” in the first place, the template task “T2011” in the second place and the template task “T2100” in the third place. Therefore, in the workflow “WF1011,” the tasks are executed in order from the template task “T2001,” the template task “T2011” to the template task “T2100.”

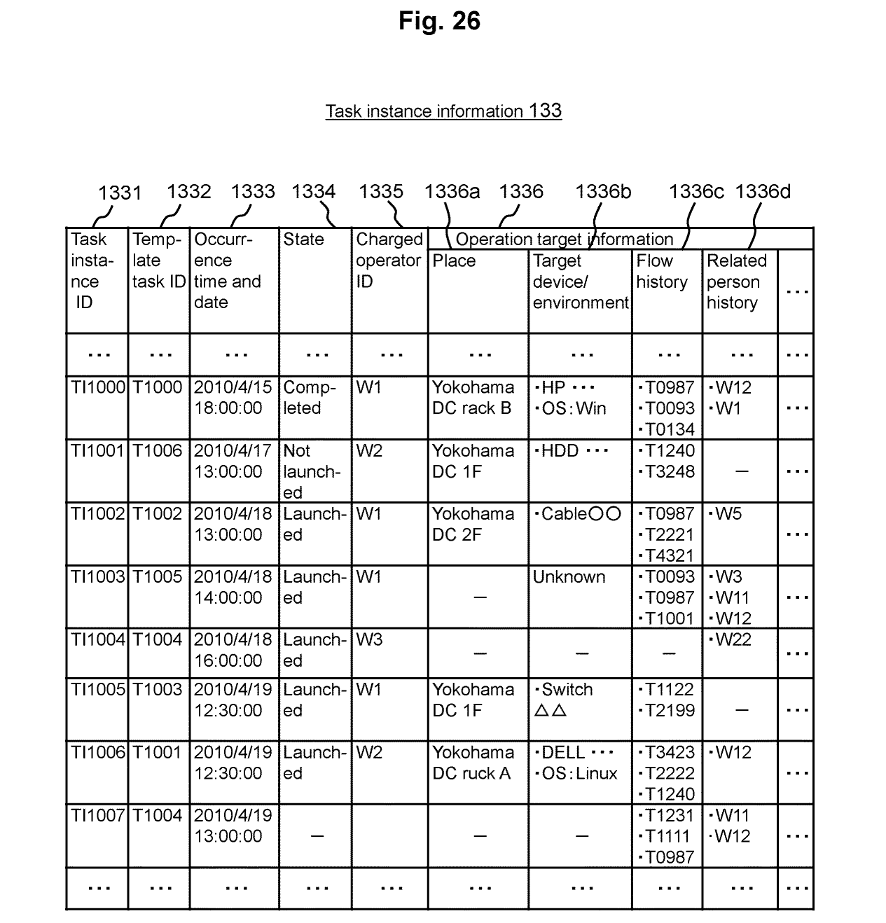

FIG. 26 is a diagram illustrating one example of task instance information according to Embodiment 2.

The task instance information 133 denotes information to manage an instance of a task (i.e. task instance) in a case where the task corresponding to a template task actually occurs. The management server 100 performs processing such as assignment or recommendation to an operator, with respect to the task instance. The task instance information 133 includes information specified at the time of task occurrence and the links to template tasks that can be defined in advance before the task occurrence (specifically, template task identifiers). The task instance information 133 includes a task instance ID 1331, a template task ID 1332, occurrence time and date 1333, a state 1334, a charged operator ID 1335, a place 1336a, a target device/environment 1336b, a flow history 1336c and an related-person history 1336d as information items. The place 1336a, the target device/environment 1336b, the flow history 1336c and the related-person history 1336d are operation target information 1336 that is information related to a person or object of a task target.

The task instance ID 1331 stores an identifier to uniquely specify a task instance. The template task ID 1332 stores a template task identifier. The occurrence time and date 1333 stores the time and date at which a task instance occurs. The state 1334 stores a task instance state. Similar to Embodiment 1, the state 1334 stores a value of “completed,” “launched” or “not launched.” The charged operator ID 1335 stores the identifier of an operator in charge of a task instance. The place 1336a stores a place in which a target object of a task instance is installed. The target device/environment 1336b stores information indicating a target object of a task instance or its circumstance. The flow history 1336c stores a history of tasks executed previously in a workflow. The related-person history 1336d stores a history of operators in charge of tasks executed previously in a workflow.

The task instance information 133 associates and manages values of the above information items 1331 to 1336 of each task instance. For example, in the example of FIG. 26, regarding a task instance having “T1000” as the task instance ID 1331 (hereinafter referred to as “task instance ‘TI1000’”), “• T0987 • T0093 • sT0134” in the flow history 1336c and “• W12 • W1” in the related-person history 1336d and the like are associated and managed. Therefore, according to the task instance information 133 in FIG. 26, by the time the task instance “TI1000” is executed, it is found that, in the same workflow, tasks having identifiers of “T0987,” “T0093” and “T0134” are executed. Also, by the time the task instance “TI1000” is executed, it is found that, in the workflow, operators having identifiers of “W12” and “W1” are involved with executing the tasks.

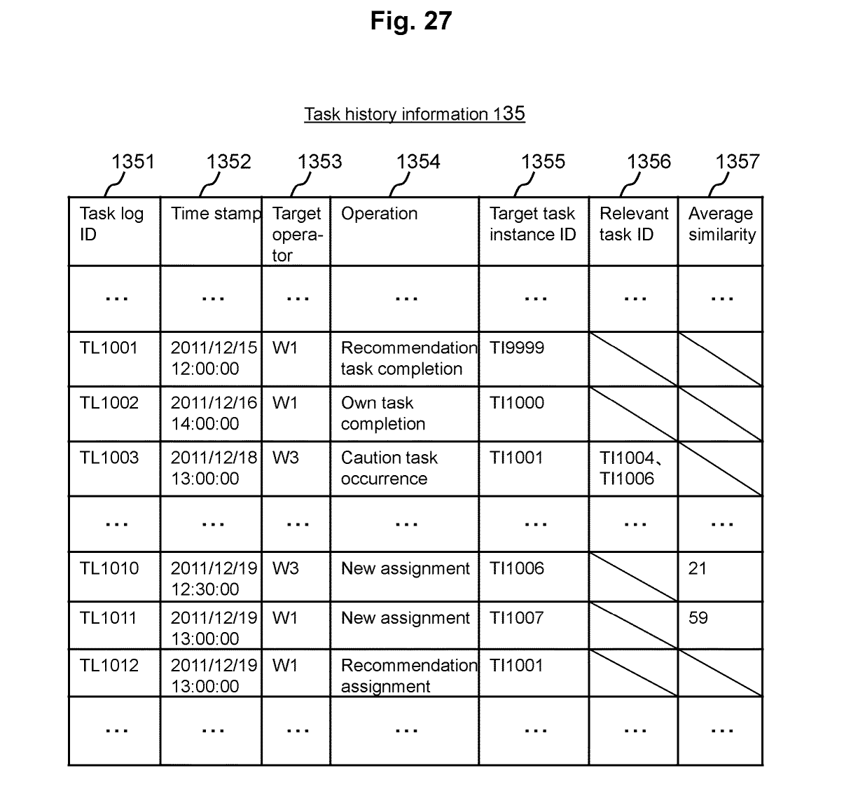

FIG. 27 is a diagram illustrating one example of task history information according to Embodiment 2.

The task history information 135 denotes information to manage a task management history. A task log ID 1351, a time stamp 1352, a target operator 1353, an operation 1354, a relevant task ID 1356 and average similarity 1357 are actually equivalent to the task log ID 1251, the time stamp 1252, the target operator 1253, the operation 1254, the relevant task ID 1256 and the average similarity 1257 in the task history information 125 in FIG. 7.

The task history information 135 includes a target task instance ID 1355 instead of the target task ID 1255 in the task information 125 in FIG. 7, as an information item. The target task instance ID 1355 stores the identifier of an operation target task instance indicated by a task log. The management server 100 according to Embodiment 2 performs processing such as new task assignment to an operator, caution task extraction and caution task recommendation, with respect to a manual task among tasks (or task instances) executed according to a workflow. That is, when the workflow is executed, although the tasks in the workflow are executed in order of the task sequence, in a case where the executed task (or task instance) is a manual task, the management server 100 performs processing such as new task assignment on the manual task. In the following, with reference to flowcharts, specific processing content performed in the management server 100 will be explained.

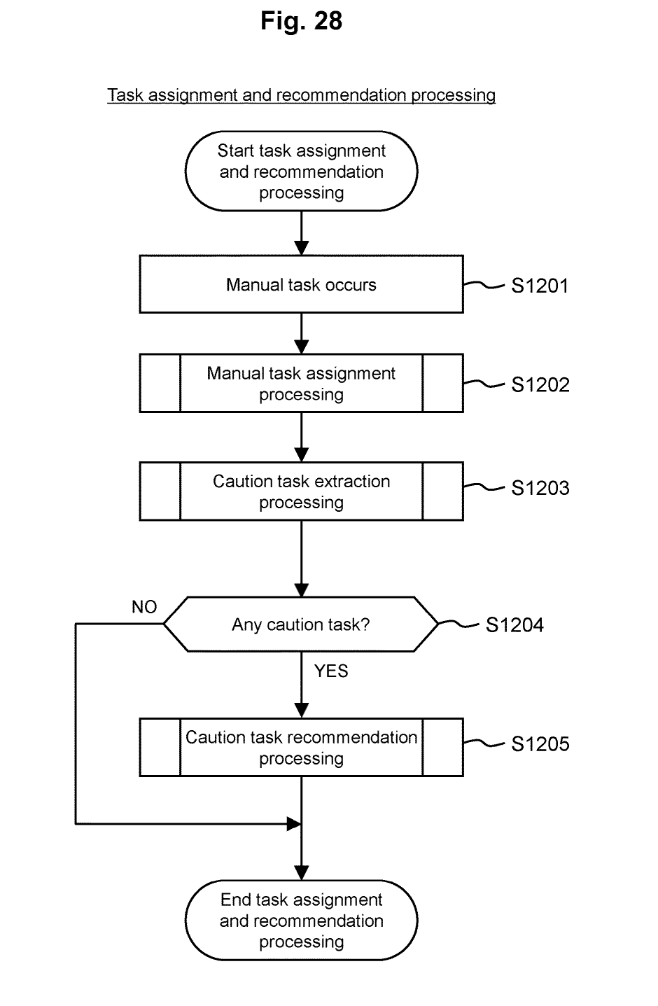

FIG. 28 is a flowchart of task assignment and recommendation processing according to Embodiment 2.

Similar to Embodiment 1, the task assignment and recommendation processing in Embodiment 2 also denotes processing of task assignment to an operator (or manual task assignment in Embodiment 2), caution task extraction and caution task recommendation.

First, when receiving an event, the new task assignment program 117 generates a new task to deal with the event, and, in a case where the new task is a manual task, stores information related to the manual task in the task instance information 133 (step S1201).

Next, the new task assignment program 117 performs manual task assignment processing (step S1202). In the manual task assignment processing, an operator to whom a task is assigned is determined for a manual task stored in the task instance information 133 in step S1201 (hereinafter simply referred to as “manual task”), and the manual task is assigned to the determined operator.

After the manual task assignment processing is finished, the new task assignment program 117 performs the processing in steps S1203 to S1205 on the manual task. The processing in steps S1203 to S1205 is similar to the processing in steps S103 to S105 of FIG. 8 in Embodiment 1. It should be noted that a manual task in Embodiment 2 corresponds to a new task in Embodiment 1.

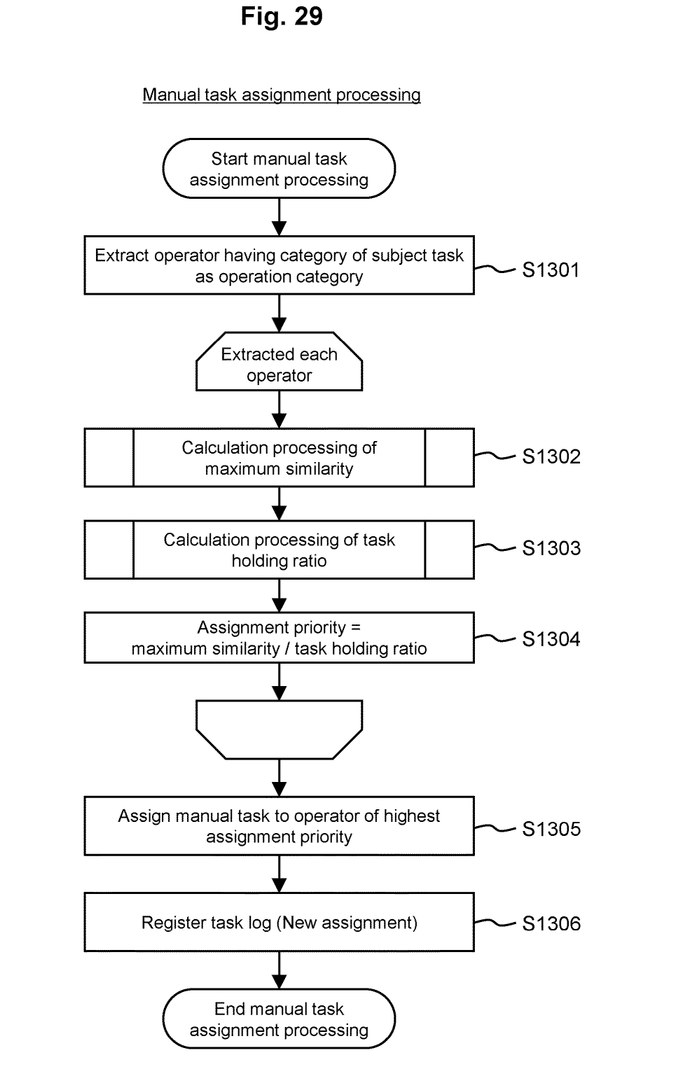

FIG. 29 is a flowchart of manual task assignment processing according to Embodiment 2.

First, the new task assignment program 117 refers to the operator information 134 and extracts operators having categories to which manual tasks belong, as a processable task category, among operators managed in the operator information 134.

Next, the new task assignment program 117 repeatedly performs the processing in step S1302 to S1304 on each of the operators extracted in step S1301. The processing in steps S1302 to S1304 is similar to the processing in steps S201 to S203 of FIG. 9 in Embodiment 1.

After the processing in steps S1302 to S1304 is completed for all the operators extracted in step S1301, the new task assignment program 117 advances the process to step S1305.

The processing in steps S1305 and S1306 is similar to the processing in steps S205 and S208 of FIG. 9 in Embodiment 1.

It should be noted that, in the above manual task assignment processing, similar to the new task assignment in FIG. 9, dynamic weighting similarity may be calculated in a case where there are a plurality of high priority operators, and a manually assigned task assignee may be determined based on the calculated dynamic weighting similarity.

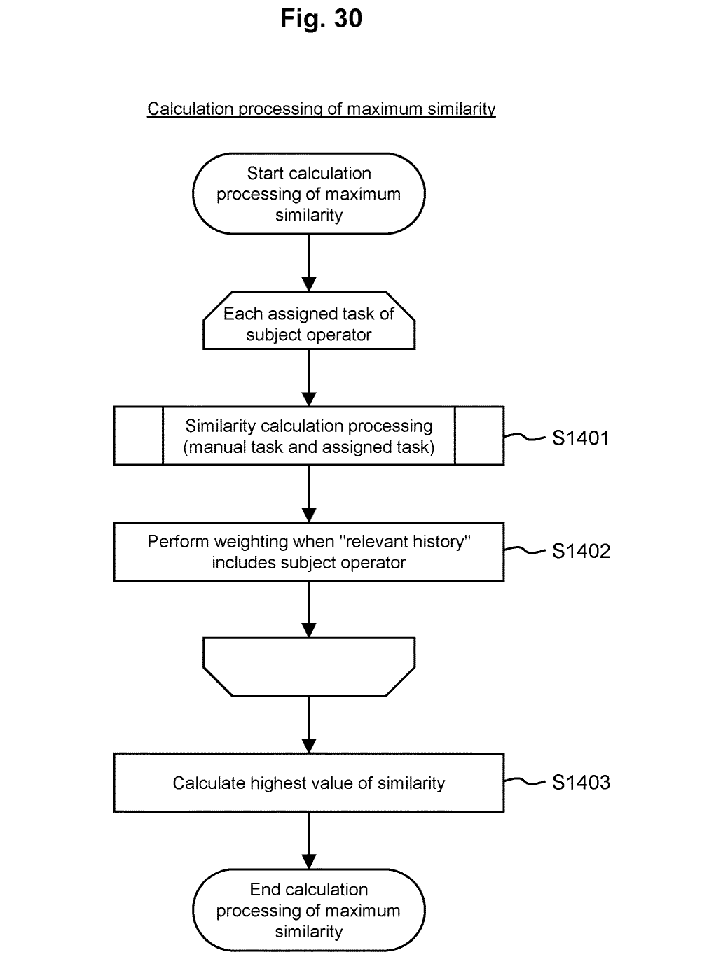

FIG. 30 is a flowchart of maximum similarity calculation processing according to Embodiment 2.

The maximum similarity calculation processing in Embodiment 2 performs processing of calculating task similarities between tasks held by a target operator and manual task, and calculating the maximum similarity having a maximum value among the calculated task similarities.

First, the task similarity calculation program 113 repeatedly performs the processing in steps S1401 and S1402 on each of tasks held by the target operator at the current time. The task similarity calculation program 113 selects one of the tasks held by the target operator (which will be referred to as “target task” in following steps S1401 and S1402).

The processing in step S1401 is similar to the processing in step S301 in the maximum similarity calculation processing of FIG. 10 in Embodiment 1.

In step S1402, the task similarity calculation program 113 refers to the related-person history 1336d corresponding to a manual task in the task instance information 133, and, in a case where operators in charge of tasks previously executed in the workflow include an operator, that is, in a case where the operator is involved with the previous operations on the workflow, the task similarity calculation program 113 weights the task similarity obtained in step S1401. To be more specific, the task similarity calculation program 113 increases (e.g. doubles) the task similarity obtained in step S1401. Thus, by increasing the task similarity of an operator who has been involved in the previous operations on the workflow, that is, who has operation experience, a new task is preferentially assigned to such an operator who has operation experience. By this means, by taking advantage of having been involved with the previous operations on the workflow, the operator who has operation experience can perform operations more efficiently than an operator who has not been involved with the previous operations, and therefore it is possible to streamline operations.

After the processing in steps S1401 and S1402 is completed for all the tasks held by the target operator, the task similarity calculation program 113 advances the process to step S1403. The processing in step S1403 is similar to the processing in step S302 of the maximum similarity calculation processing in FIG. 10.

According to above Embodiment 2, by performing task assignment taking into account a previous execution history on a workflow (in the present embodiment, task history and charged person history), for example, a task can be preferentially assigned to an operator having operation experience and the same task in which the previous execution history varies can be distinguished and assigned (e.g. cases where the previously-executing operator is Japanese and the previously-executing operator is Indian are distinguished and assigned), and, as a result, a task is assigned to a more suitable operator and an operational performance efficiency is improved. It should be noted that, if the previous execution history varies in the same task, since there arise differences in its report route or the like, by taking into account history content, it is possible to assign a task to a more suitable operator taking into account the above differences.

It should be noted that the present invention is not limited to the above several embodiments described above, and it is needless to say that various changes may be made without departing from the scope of the gist.

For example, in Embodiment 1, in a case where there are a plurality of high priority operators, dynamic weighting similarity is calculated for each of the high priority operators and a new task assignee is determined based on the calculated dynamic weighting similarity, but this processing needs not be necessarily performed. For example, based on the calculated dynamic weighting similarity, assignment priority may be recalculated and the new task assignee may be determined based on the recalculated assignment priority.

Also, since Embodiment 2 is designed so as to take into account the previous execution history in a workflow at the time of task assignment, although task similarity is weighted, this needs not be necessarily performed. For example, it may be possible to define an equation to calculate assignment priority such that the above history content reflects a value of assignment priority without changing task similarity, or it may be possible to weight assignment priority based on the history content.

### REFERENCE SIGNS LIST

100 Management server computer
200 Management target device
300 Management client computer
400 Communication network

1. A task management method by a task management apparatus configured to assign tasks to a plurality of operators, comprising:
calculating a task similarity between a newly generated first task and a second task that is already assigned to an operator, for each of the operators, based on task information including, for each generated task, operation target information for which a value is determined according to a state at a time of task occurrence and which is related to a task target; and
determining an operator to whom the first task is assigned according to an assignment priority based on the task similarity calculated for each of the operators.

2. A task management method according to claim 1, wherein the operation target information includes information of an organization related to the task target and/or information of a user related to the task target.

3. A task management method according to claim 2, wherein the task information includes a plurality of information items, the method further comprising:
calculating an item similarity, which is a similarity for each of the information items between the first task and the second task, for each of the operators;
in a case where there are a plurality of high priority operators who have high assignment priority, calculating a weight for each of the information items based on a difference of the item similarity between the high priority operators for each of the information items;
calculating a weighting item similarity in consideration of the calculated weight in a plurality of the item similarities, for each of the high priority operators, and calculating a weighting task similarity based on the weighting item similarities; and
determining an operator to whom the first task is assigned based on the weighting similarity calculated for each of the high priority operators, instead of the assignment priority.

4. A task management method according to claim 3, further comprising:
determining an operator having an assignment priority within a range between a maximum value of the assignment priority and a predetermined first threshold, as the high priority operator;
accepting an input of the first threshold before the determination is made; and
determining whether there are the plurality of high priority operators.

5. A task management method according to claim 4, further comprising:
calculating the task similarity with respect to each of one or more second tasks and storing a maximum value of the one or more calculated task similarities as a maximum task similarity of an operator in the storage device, for each of one or more first tasks;
calculating an average value of a plurality of maximum task similarities based on the plurality of maximum task similarities, which are stored in the storage device and related to an operator, for each of the operators, after determining an operator to whom the one or more first tasks is assigned; and
displaying the average value of the maximum task similarities calculated for each of the operators.

6. A task management method according to claim 5, wherein the task information further includes an occurrence time and date of the task, the method further comprising:
extracting a third task that is not executed even when a predetermined time elapsed from an occurrence, among tasks that are already assigned to operators;
calculating a recommendation priority as an index to recommend an execution of the third task to the operator to whom the first task is assigned, based on a task similarity between the third task and the first task and an importance of the third task; and
recommending the execution of the third task to the operator to whom the first task is assigned in a case where the calculated recommendation priority is equal to or higher than a predetermined second threshold.

7. A task management method according to claim 6, wherein:
the storage device further stores a workflow to define an execution order of tasks; and
the task information further includes history information before the execution of the tasks starts, in the workflow related to the tasks,
the method further comprising determining the operator to whom the first task is assigned based on the assignment priority and the history information related to the first task.

8. A task management apparatus configured to assign tasks to a plurality of operators, comprising:
a storage device; and
a control device coupled to the storage device,
wherein the storage device is configured to store task information including, for each generated task, operation target information for which a value is determined according to a state at a time of task occurrence and which is related to a task target, and
wherein the control device is configured to calculate a task similarity between a newly generated first task and a second task that is already assigned to an operator, for each of the operators, based on the task information, and determine an operator to whom the first task is assigned according to an assignment priority based on the task similarity calculated for each of the operators.

9. A task management apparatus according to claim 8, wherein the operation target information includes information of an organization related to the task target and/or information of a user related to the task target.

10. A task management apparatus according to claim 8, wherein the task information includes a plurality of information items,
wherein the control device is configured to calculate an item similarity, which is a similarity for each of the information items between the first task and the second task, for each of the operators,
wherein the control device is configured to, in a case where there are a plurality of high priority operators who have high assignment priority, calculate a weight for each of the information items based on a difference of the item similarity between the high priority operators for each of the information items,
wherein the control device is configured to calculate a weighting item similarity in consideration of the calculated weight in a plurality of the item similarities, for each of the high priority operators, and calculate a weighting task similarity based on the weighting item similarities, and
wherein the control device is configured to determine an operator to whom the first task is assigned based on the weighting similarity calculated for each of the high priority operators, instead of the assignment priority.

11. A task management apparatus according to claim 8, further comprising an input device configured to accept an input,
wherein the control device is configured to determine an operator having an assignment priority within a range between a maximum value of the assignment priority and a first threshold, as the high priority operator,
wherein the control device is configured to accept an input of the first threshold by the input device before the determination is made, and
wherein the control device is configured to determine whether there are the plurality of high priority operators.

12. A task management apparatus according to claim 8, further comprising an output device,
wherein the control device is configured to calculate the task similarity with respect to each of one or more second tasks and store a maximum value of the one or more calculated task similarities as a maximum task similarity of an operator in the storage device, for each of one or more first tasks,
wherein the control device is configured to calculate an average value of a plurality of maximum task similarities based on the plurality of maximum task similarities, which are stored in the storage device and related to an operator, for each of the operators, after determining an operator to whom the one or more first tasks is assigned, and
wherein the control device is configured to display the average value of the maximum task similarities calculated for each of the operators, on the output device.

13. A task management apparatus according to claim 8, wherein the task information further includes an occurrence time and date of the task related to the information,
wherein the control device is configured to extract a third task that is not executed even when a predetermined time elapsed from an occurrence of a task, among tasks that are already assigned to operators,
wherein the control device is configured to calculate a recommendation priority as an index to recommend an execution of the third task to the operator to whom the first task is assigned, based on a task similarity between the third task and the first task and an importance of the third task, and
wherein the control device is configured to recommend the execution of the third task to the operator to whom the first task is assigned in a case where the calculated recommendation priority is equal to or higher than a predetermined second threshold.

14. A task management apparatus according to claim 8, wherein the storage device further stores a workflow to define an execution order of tasks,
wherein the task information further includes history information before the execution of the tasks starts, in the workflow related to the tasks, and
wherein the control device is configured to determine the operator to whom the first task is assigned based on the assignment priority and the history information related to the first task.

15. A computer program that causes a computer to:
realize a task management apparatus configured to assign tasks to a plurality of operators;
calculate a task similarity between a newly generated first task and a second task that is already assigned to an operator, for each of the operators, based on task information including, for each generated task, operation target information for which a value is determined according to a state at a time of task occurrence and which is related to a task target; and
determine an operator to whom the first task is assigned according to an assignment priority based on the task similarity calculated for each of the operators.
